(19) United States
(12) Patent Application Publication
(10) Pub. No.: US 2012/0164532 A1
(43) Pub. Date: Jun. 28, 2012

(54) LITHIUM ION SECONDARY BATTERY, POSITIVE ELECTRODE ACTIVE MATERIAL, POSITIVE ELECTRODE, ELECTRIC TOOL, ELECTRIC VEHICLE, AND POWER STORAGE SYSTEM

(75) Inventors: Masaharu Senoue, Fukushima (JP); Kenichi Kawase, Fukushima (JP); Nozomu Morita, Fukushima (JP); Kazuaki Endoh, Fukushima (JP); Akira Takamuku, Fukushima (JP); Yosuke Hosoya, Fukushima (JP); Guohua Li, Saitama (JP)

(73) Assignee: Sony Corporation, Tokyo (JP)

(21) Appl. No.: 13/315,040

(22) Filed: Dec. 8, 2011

(30) Foreign Application Priority Data
Dec. 28, 2010 (JP) 2010-293270

(51) Int. Cl. H01M 4/525; H01M 4/48; H01M 4/38; H01M 4/54; H01M 4/58

(52) U.S. Cl. 429/219; 429/223; 429/220; 429/221; 429/222

(57) ABSTRACT

A lithium ion secondary battery includes a positive electrode, a negative electrode, and an electrolytic solution, wherein the positive electrode includes a first lithium composite oxide and a second lithium composite oxide expressed by the following equation (1), as a positive electrode active material, and a charge capacity (vs lithium metal) per unit volume during a charge and discharge of a first cycle is larger in the second lithium composite oxide compared to the first lithium composite oxide, and a discharge voltage (vs lithium metal) during the charge and discharge of the first cycle is lower in the second lithium composite oxide compared to the first lithium composite oxide, Li₁₊ₐ(Mn_{b}Co_{c}Ni_{1-b-c})₁₋ₐO₂ . . . (1), where a, b, and c satisfy relationships of 0<a≦0.25, 0.5≦b<0.7, and 0≦c<1−b.

### CROSS REFERENCE TO RELATED APPLICATION

The present application claims priority to Japanese Patent Application No. 2010-293270 filed on Dec. 28, 2010, the disclosure of which is incorporated herein by reference.

### BACKGROUND

The present disclosure relates to a positive electrode active material containing a composite oxide including lithium and a transition metal as a constituent element, a positive electrode and a lithium ion secondary battery that use the positive electrode active material, an electric tool and an electric vehicle that use the lithium ion secondary battery, and a power storage system.

In recent years, a small-sized electronic apparatus represented by a portable terminal device or the like has become widespread, and a further reduction in size and weight, and a long operational lifespan are strongly required. Along with this, a development of a battery as a power source, particularly, a secondary battery, which is small in size and is light in weight, and which can obtain a high energy density, has been progressed. In recent years, this secondary battery has been reviewed for an application for use in a large-sized electronic apparatus such as a vehicle while not being limited to a small-sized electronic apparatus.

As secondary batteries, secondary batteries using various charge and discharge principles have been widely proposed, but among these, a lithium ion secondary battery using occlusion and emission of lithium ions has attracted attention. This is because an energy density higher than that in a lead battery, a nickel-cadmium battery, or the like, is obtained.

The lithium ion secondary battery includes a positive electrode, a negative electrode, and an electrolytic solution, and the positive electrode and the negative electrode include a positive electrode active material and a negative electrode active material that occludes and emits lithium ions, respectively. As the positive electrode active material, LiCoO₂ or LiNiO₂ that are composite oxides including lithium and a transition metal as a constituent element are widely used so as to obtain a high battery capacity. However, in recent years, to improve various battery performances including not only a battery capacity but also cycle characteristics or the like, a method where a composite oxide having a different composition instead of LiCoO₂ or the like has been used or a method where these are used together has been reviewed.

Specifically, to sufficiently utilize a high capacity characteristic of an Si-based or Sn-based negative electrode active material, there is suggested a method where a first contained Li transition metal composite oxide that is a main component and a second contained Li transition metal composite oxide (Li(LiₓMn₂ₓCo₁₋₃ₓ)O₂: 0<x<1/3) that is an auxiliary component are used together (for example, refer to Japanese Unexamined Patent Application Publication No. 2009-158320). The first contained Li transition metal composite oxide includes LoCoO₂, Li(CoₐMn_{b}Ni_{c}O₂: all of a, b, and c are integers and a+b+c=1), or the like, and the second contained Li transition metal composite oxide includes Li(Li_{0.2}Mn_{0.4}Co_{0.4})O₂ or the like.

In addition, for the same purpose, there is suggested a method where a lithium-rich composite oxide (LiₕMnᵢCoⱼNiₖO₂) is used (refer to Japanese Unexamined Patent Application Publication No. 2009-158415). Here, h=[3(1+x)+4a]/3(1+a), i=[3α(1+x)+2a]/3(1+a), j=β(1−x)/(1+a), k=γ(1−x)/(1+a), 0<a<1, α>0, β>0, γ>0, α+β+γ=1, 0≦x<1/3. This composite oxide is a solid solution expressed by Li₁₊ₓ(MnαCoβNiγ)₁₋ₓO₂.aLi_{4/3}Mn_{2/3}O₂.

To obtain an excellent charge and discharge characteristic at a high voltage, there is proposed a method where a lithium-rich lithium composite oxide (Li₁₊ₐ[Mn_{b}Co_{c}Ni_{1-b-c}]₁₋ₐO_{2-d}: 0<a<0.25, 0.5≦b<0.7, 0≦c<1−b, −0.1≦d≦0.2) is used (refer to Japanese Unexamined Patent Application Publication No. 2007-220630). This lithium composite oxide includes Li_{1.05}-[Mn_{0.6}Co_{0.2}Ni_{0.2}]_{0.95}O₂ or the like.

### SUMMARY

To obtain a high battery capacity even when a charge and discharge is repeated, it is necessary to compensate for an irreversible capacity occurring in a negative electrode during a charge and discharge of the first time (first cycle), and to reliably obtain a high energy density during a charge and discharge after the first time (from a second cycle). However, in a lithium ion secondary battery in the related art, it is difficult for the compensation for the irreversible capacity during the charge and discharge of the first time and the securing of the high energy density during the charge and discharge after the first time to be compatible with each other.

The present disclosure has been made in consideration of the above-described problems, and it is desirable to provide a positive electrode active material, a positive electrode, a lithium ion secondary battery, an electric tool, an electric vehicle, and a power storage system, in which the compensation for the irreversible capacity during a charge and discharge of the first time and the securing of the high energy density during a charge and discharge after the first time are compatible and therefore a high battery capacity can be stably obtained, even when the charge and discharge is repeated.

According to an embodiment of the present disclosure, there is provided a positive electrode active material including a first lithium composite oxide, and a second lithium composite oxide expressed by the following equation (1). However, a charge capacity (vs lithium metal) per unit volume during a charge and discharge of a first cycle is larger in the second lithium composite oxide compared to the first lithium composite oxide. In addition, a discharge voltage (vs lithium metal) during the charge and discharge of the first cycle is lower in the second lithium composite oxide compared to the first lithium composite oxide.

Li₁₊ₐ[Mn_{b}Co_{c}Ni_{1-b-c}]₁₋ₐO₂ (1)

(here, a, b, and c satisfy relationships of 0<a≦0.25, 0.5≦b<0.7, and 0≦c<1−b)

According to another embodiment of the present disclosure, there is provided a positive electrode including the positive electrode active material. In addition, according to still another embodiment of the present disclosure, there is provided a lithium ion secondary battery including a positive electrode, a negative electrode, and an electrolytic solution, wherein the positive electrode includes the above-described positive electrode active material. Furthermore, according to still another embodiment of the present disclosure, there is provided an electric tool, an electric vehicle, and a power storage system which use the above-described lithium ion secondary battery.

Here, the lithium composite oxide may be a composite oxide including one kind or two kinds or more of transition metal together with lithium (Li) as a constituent element. The lithium composite oxide may further include another element other than the transition metal element.

The charge capacity (vs lithium metal) per unit volume of the first lithium composite oxide during the charge and discharge of the first cycle may be an actual value of an inherent charge capacity in the first lithium composite oxide and may be obtained by manufacturing a test secondary battery in which lithium metal is used for a counter electrode. Specifically, a test secondary battery in which the first lithium composite oxide and lithium metal are used for a test electrode and a counter electrode, respectively, may be manufactured, and the secondary battery may be charged and a charge capacity (mAh) may be measured. Detailed conditions in the case of measuring the charge capacity will be described with reference to examples described later. From a measured charge capacity, a weight (g) and a true density (g/cm³) of the first lithium composite oxide, a charge capacity per unit volume (mAh/cm³) of [charge capacity (mAh)/weight (g)]×true density (g/cm³) may be calculated. In addition, with respect to the second lithium composite oxide, the charge capacity (vs lithium metal) per unit volume during the charge and discharge of the first cycle may be obtained through the same sequence as the first lithium composite oxide.

In addition, a discharge voltage (vs lithium metal) of the first lithium composite oxide during the charge and discharge of the first cycle may be an actual value of an inherent discharge capacity in the first lithium composite oxide, and may be obtained by manufacturing a test secondary battery similarly to the case of obtaining the charge capacity per unit volume. Specifically, the secondary battery may be charged and discharged and thereby a discharge voltage (V) may be measured. Detailed conditions in the case of measuring the discharge voltage will be described with reference to examples described later. In addition, with respect to the second lithium composite oxide, the discharge voltage (vs lithium metal) per unit volume during the charge and discharge of the first cycle may be measured through the same sequence as the first lithium composite oxide.

According to the positive electrode active material, the positive electrode, or the lithium ion secondary battery of the embodiments of the present disclosure, a first lithium composite oxide and a second lithium composite oxide expressed by equation (1) are included. However, a charge capacity (vs lithium metal) per unit volume during a charge and discharge of a first cycle is larger in the second lithium composite oxide compared to the first lithium composite oxide, and a discharge voltage (vs lithium metal) during the charge and discharge of the first cycle is lower in the second lithium composite oxide compared to the first lithium composite oxide. In this case, when the lithium ion secondary battery using the positive electrode active material is charged and discharged, the second lithium composite oxide is preferentially used during a charge and discharge of the first time, such that an irreversible capacity is compensated by the second lithium composite oxide. In addition, during the charge and discharge after the first time, the first lithium composite oxide is preferentially used, such that a high battery capacity may be obtained by the first lithium composite oxide with a high energy density. Therefore, the compensation for the irreversible capacity during the charge and discharge of the first time and the securing of the high energy density during the charge and discharge after the first time may be compatible, such that it is possible to obtain a high battery capacity even when the charge and discharge is repeated. In addition, in regard to an electric tool, an electric vehicle, and a power storage system which use the above-described lithium ion secondary battery, it is possible to obtain the same effect.

Additional features and advantages are described herein, and will be apparent from the following Detailed Description and the figures.

### BRIEF DESCRIPTION OF THE FIGURES

FIG. 1 is a cross-sectional view illustrating a configuration of a lithium ion secondary battery (cylinder type) using a positive electrode active material according to an embodiment of the present disclosure;

FIG. 2 is an enlarged cross-sectional view illustrating a part of a wound electrode body shown in FIG. 1 according to an embodiment of the present disclosure;

FIG. 3 is a perspective view illustrating a configuration of another lithium ion secondary battery (laminated film type) using the positive electrode active material according to the embodiment of the present disclosure;

FIG. 4 is a cross-sectional view illustrating the wound electrode body, which is taken along a line IV-IV in FIG. 3 according to an embodiment of the present disclosure; and

FIG. 5 is a cross-sectional view illustrating a configuration of a test secondary battery (coin type) according to an embodiment of the present disclosure.

### DETAILED DESCRIPTION

Embodiments of the present application will be described below in detail with reference to the drawings.

Hereinafter, an embodiment of the present disclosure will be described in detail with reference to the attached drawings. In addition, the description will be made in the following order.

1. Positive Electrode Active Material

2. Application Example of Positive Electrode Active Material

2-1. Positive Electrode and Lithium Ion Secondary Battery (Cylinder Type)

2-2. Positive Electrode and Lithium Ion Secondary Battery (Laminated Film Type)

3. Usage of Lithium Ion Secondary Battery

### 1. Positive Electrode Active Material

### Configuration of Positive Electrode Active Material

A positive electrode active material is used for a positive electrode of, for example, a lithium ion secondary battery (hereinafter, referred to as “secondary battery”).

The positive electrode active material includes a first lithium composite oxide and a second lithium composite oxide expressed by the following equation (1). However, a charge capacity (vs lithium metal) per unit volume during a charge and discharge of a first cycle is larger in the second lithium composite oxide compared to the first lithium composite oxide. In addition, a discharge voltage (vs lithium metal) during the charge and discharge of the first cycle is lower in the second lithium composite oxide compared to the first lithium composite oxide.

Li₁₊ₐ(Mn_{b}Co_{c}Ni_{1-b-c})₁₋ₐO₂ (1)

(here, a, b, and c satisfy relationships of 0<a≦0.25, 0.5≦b<0.7, and 0≦c<1−b)

The first lithium composite oxide is a lithium transition metal composite oxide including one kind or two kinds or more of transition metal or the like together with lithium (Li). The kind of the first lithium composite oxide is not limited as long as a charge capacity (vs lithium metal) per unit volume during a charge and discharge of a first cycle is smaller than that in the second lithium composite oxide, and a discharge voltage (vs lithium metal) during the charge and discharge of the first cycle is higher than in the second lithium composite oxide.

The first lithium composite oxide in which a charge capacity per unit volume is relatively small is preferentially used in order for a positive electrode active material to occlude and emit lithium ions mainly during a charge and discharge after the first time (from a second cycle) of the secondary battery.

Among these, it is preferable that the first lithium composite oxide be at least one kind among compounds expressed by the following equations (2) to (4). This is because during a charge and discharge after the first time, which is performed at the time of an actual use of the secondary battery, it is possible to obtain a high energy density (battery capacity) and cycle characteristics are improved.

Li_{d}Ni_{1-e-f}MnₑM1_{f}O_{2-g}Xₕ (2)

(here, M1 is at least one kind among elements (excluding nickel and manganese) of group 2 to group 15 in an extended periodic table of elements and X is at least one kind among elements of group 16 and group 17 (excluding oxygen); d, e, f, g, and h satisfy relationships of 0≦d≦1.5, and 0≦e≦1, 0≦f≦1, −0.1≦g≦0.2, and 0≦h≦0.2)

LiⱼMn₂₋ₖM2ₖOₘFₙ (3)

(here, M2 is at least one kind selected from a group consisting of cobalt, nickel, magnesium (Mg), aluminum (Al), boron, titanium, vanadium (V), chromium (Cr), iron, copper, zinc, molybdenum, tin, calcium (Ca), strontium (Sr), and tungsten (W); j, k, m, and n satisfy relationships of j≧0.9, 0≦k≦0.6, 3.7≦m≦4.1, and 0≦n≦0.1)

LiₚM3_{q}PO₄ (4)

(here, M3 is at least one kind among elements of group 2 to group 15 in an extended periodic table of elements; p and q satisfy relationships of 0≦p≦2, and 0.5≦q≦2)

The compound expressed by equation (2) is a layered type. In equation (2), a kind of M1 is not particularly limited as long as M1 is at least one kind among elements of group 2 to group 15 (excluding nickel and manganese) in an extended periodic table of elements. For example, M1 is at least one kind selected from a group consisting of cobalt, magnesium, aluminum, boron, titanium, vanadium, chromium, iron, copper, zinc, zirconium (Zr), molybdenum (Mo), tin (Sn), calcium, strontium, and tungsten. In addition, a kind of X is not particularly limited as long as X is one kind among elements of group 16 and group 17 (excluding oxygen). For example, X is halogen such as fluorine (F). A specific example of the compound expressed by equation (2) includes LiNiO₂, LiCoO₂, LiNi_{0.8}Co_{0.18}Al_{0.02}O₂, or the like.

The compound expressed by equation (3) is a spinel type and includes LiMn₂O₄ or the like.

The compound expressed by equation (4) is an olivine type. In equation (4), a kind of M3 is not particularly limited as long as M3 is at least one kind among elements of group 2 to group 15 in an extended periodic table of elements. For example, M3 is at least one kind selected from a group consisting of cobalt, manganese, iron, nickel, magnesium, aluminum, boron, titanium, vanadium, niobium, copper, zinc, molybdenum, calcium, strontium, tungsten, and zirconium. A specific example of the compound expressed by equation (4) includes LiFePO₄ or the like.

The second lithium composite oxide is a lithium-rich lithium transition metal composite oxide including manganese, cobalt, and nickel that are transition metals together with lithium as a constituent element. In addition, in equation (1), as is clear from a value which b and c may have, manganese is included in the second lithium composite oxide, but cobalt and nickel are not necessarily included in the second lithium composite oxide.

The second lithium composite oxide having a relatively large charge capacity per unit volume is preferentially used in order for a positive electrode active material to occlude and emit lithium ions during a charge and discharge of a secondary battery of the first time (first cycle), differently from the first lithium composite oxide. During the charge and discharge of the secondary battery of the first time, a stable film (SEI film or the like) is formed on a surface of a negative electrode, such that it is known that an irreversible capacity occurs. Along with this, the lithium ions that are occluded and emitted from the first lithium composite oxide during the charge and discharge of the first time are consumed to form the above-described film (causes an irreversible capacity).

In addition, in a case where the negative electrode active material of the negative electrode is formed of a metal-based material including at least one of silicon and tin as a constituent element, or an oxide thereof (for example SiO or the like), the irreversible capacity may occur. This is because the lithium ions emitted from the positive electrode active material during the charge and discharge of the first time irreversibly couple with silicon, oxygen, or the like. The above-described metal-based material is, for example, at least one kind among an elementary substance, an alloy, and a compound of silicon, and an elementary substance, an alloy, and a compound of tin, or the like. An oxide of the metal-based material includes, for example, a silicon oxide (SiOₓ: 0.2<x<1.4).

Here, the reason why the positive electrode active material includes the first and second lithium composite oxide is that during a charge and discharge after the first time which is performed at the time of an actual use of the secondary battery, it is possible to obtain a high battery capacity through role-sharing of the first and second lithium composite oxides.

More specifically, when the positive electrode active material includes only the first lithium composite oxide, although a sufficient amount of the first lithium composite oxide is necessary to obtain a high energy density during a charge and discharge after the first time, since the irreversible capacity occurs during the charge and discharge of the first time, a part of the first lithium composite oxide is unintentionally over-consumed. Therefore, since an absolute amount of the first lithium composite oxide that can be used during the charge and discharge after the first time decreases, it is difficult to obtain a sufficient battery capacity. On the other hand, when the positive electrode active material includes only the second lithium composite oxide, it is difficult to obtain a sufficient energy density compared to the first lithium composite oxide, and a charge capacity after the first time enormously decreases rather than the charge capacity of the first time, such that it is difficult to obtain a sufficient charge capacity during the charge and discharge after the first time.

On the contrary, when the positive electrode active material includes the first and second lithium composite oxide, since the irreversible capacity occurs during the charge and discharge of the first time, the second lithium composite oxide is preferentially consumed, and the first lithium composite oxide is maintained while being slightly consumed. That is, the second lithium composite oxide performs a function of taking over (compensating) for the first lithium composite oxide which is used to cause the irreversible capacity. In this manner, an absolute amount of the first lithium composite oxide that can be used during the charge and discharge after the first time is secured, such that it is possible to obtain a high energy density (battery capacity) during the charge and discharge after the first time. In this case, the second lithium composite oxide is substantially consumed during the charge and discharge of the first time, such that it is possible to obtain substantially the same cycle characteristics as a case where only the first lithium composite oxide is used during the charge and discharge after the first time without using the second lithium composite oxide.

The above-described advantage is effective in a case where a charge and discharge efficiency in a negative electrode is lower than that in a positive electrode. That is, in a case where the negative electrode includes a negative electrode active material, it is preferable that a charge and discharge efficiency (a discharge capacity (vs lithium metal) per unit volume during the charge and discharge of the first cycle/a charge capacity (vs lithium metal) per unit volume during the charge and discharge of the first cycle) be higher in the first lithium composite oxide compared to the negative electrode active material.

More specifically, in a case where a metal-based material is used as the negative electrode active material, to suppress the negative electrode from being intensely expanded and contracted during a charge and discharge, it is preferable to lower a utilization ratio of the negative electrode (make a positive electrode capacity lower than a negative electrode capacity). In this case, a ratio of lithium ions consumed in forming an SEI film or the like with respect to a total charge capacity of the negative electrode becomes large, such that the charge and discharge efficiency of the negative electrode decreases. In addition, in a case where a metal-based oxide is used as the negative electrode active material, the expansion and contraction of the negative electrode is more suppressed than the case of using the metal-based material, such that it is possible to increase a utilization ratio of the negative electrode, but a part of lithium ions irreversibly couples with oxygen during the charge and discharge of the first time, such that the charge and discharge efficiency of the negative electrode also decreases.

In this regard, when the positive electrode active material includes the first and second lithium composite oxides, as described above, an absolute amount of the first lithium composite oxide that is consumed during the charge and discharge of the first time is suppressed to be small, and an absolute amount of the first lithium composite oxide that is used for generating a battery capacity during the charge and discharge after the first time is secured. Therefore, even when the charge and discharge efficiency of the negative electrode is low, it is possible to obtain as high a battery capacity as possible. Therefore, the positive electrode active material including the first and second lithium composite oxides is effective in a case where the charge and discharge efficiency of the negative electrode is lower than the charge and discharge efficiency of the positive electrode.

The reason why a charge capacity (vs lithium metal) per unit volume during the charge and discharge of the first time is larger in the second lithium composite oxide compared to the first lithium composite oxide is that the second lithium composite oxide is preferentially consumed rather than the first lithium composite oxide to form a film during the charge and discharge of the first time, such that an amount of consumption of the second lithium composite oxide may be small. In this manner, an absolute amount (occupancy with respect to the entirety of the positive electrode active material) of the first lithium composite oxide that can be used to obtain a battery capacity during the charge and discharge after the first time is secured, such that a battery capacity increases.

The discharge voltage (vs lithium metal) during the charge and discharge of the first cycle is lower in the second lithium composite oxide compared to the first lithium composite oxide; this is because lithium ions are preferentially occluded to the first lithium composite oxide during the charge and discharge of the first time, such that the charge and discharge after the first time is performed in a state where the lithium ions are sufficiently occluded to the first lithium composite oxide. In this manner, in the charge and discharge after the first time, it is possible to obtain a high battery capacity by using a discharge voltage of the first lithium composite oxide higher than that of the second lithium composite oxide.

Particularly, in the first and second lithium composite oxides, it is preferable that a charge capacity ratio (a charge capacity (vs lithium metal) per unit volume during a charge and discharge of a second cycle/a charge capacity (vs lithium metal) per unit volume during the charge and discharge of the first cycle) be larger in the first lithium composite oxide compared to the second lithium composite oxide. This is because it is possible to obtain a high battery capacity by the second lithium composite oxide during the charge and discharge after the first time.

Characteristic values of the above-described first lithium composite oxide, that is, the charge capacity (vs lithium metal) and the discharge capacity (vs lithium metal) per unit volume are actual values of inherent charge capacity and discharge capacity of the first lithium composite oxide, such that it is possible to obtain these capacities by manufacturing a test secondary battery in which lithium metal is used as a counter electrode. In addition, a characteristic value of the second lithium composite oxide is also obtained by the same sequence.

In a case of obtaining a charge capacity per unit volume, a test secondary battery in which the first lithium composite oxide and lithium metal are used for a test electrode and a counter electrode, respectively, is manufactured, and the secondary battery is charged and a charge capacity (mAh) is measured. From the measured charge capacity, a weight (g) and a true density (g/cm³) of the first lithium composite oxide, a charge capacity per unit volume (mAh/cm³) of [charge capacity (mAh)/weight (g)]×true density (g/cm³) is calculated. Measurement conditions of the charge capacity (mAh) will be described with reference to examples described later.

In addition, in the case of obtaining a discharge voltage (vs lithium metal), similarly to the case of obtaining the charge capacity per unit volume, a test secondary battery is manufactured, the secondary battery is charged and discharged, and the discharge voltage (V) is measured. Measurement conditions of the discharge voltage will be described with reference to examples described later.

In addition, in a case where the positive electrode active material is assembled to the secondary battery, as described below, it is preferable that characteristic values of the first and second lithium composite oxide be investigated in a region where a charge and discharge does not occur due to an insulating protective tape that is provided at a center of the positive electrode. In this region, a state before a charge and discharge (not charged and discharged state) is maintained, such that it is possible to investigate characteristic values of the first and second lithium composite oxides regardless of whether or not a charge and discharge occurs.

A mixing ratio of the first and second lithium composite oxides is not particularly limited, but it is preferable that a proportion of the first lithium composite oxide be larger than that of the second lithium composite oxide. This is because during the charge and discharge of the first time, it is necessary to stably obtain a high battery capacity during the charge and discharge after the first time by the sufficient amount of first lithium composite oxide while compensating for an irreversible capacity by the smallest amount of the second lithium composite oxide.

More specifically, in a case where an irreversible capacity generated in the negative electrode during the charge and discharge of the first time is Z % with respect to a total charge capacity (vs positive electrode) of the negative electrode, it is preferable that a ratio of the second lithium composite oxide in the first and second lithium composite oxides be set in such a manner that a charge capacity (vs negative electrode) of the second lithium composite oxide becomes Z % or less with respect to a total charge capacity of the positive electrode. For example, when the irreversible capacity is 30% with respect to the total charge capacity of the negative electrode, it is preferable that the proportion of the second lithium composite oxide be set in such a manner that the charge capacity becomes 30% or less with respect to the total charge capacity of the positive electrode.

### Method of Analyzing Positive Electrode Active Material

To confirm that the positive electrode active material includes the first and second lithium composite oxide, the positive electrode active material may be analyzed using various element analyzing methods. These element analyzing methods include, for example, an X-ray diffraction (XRD) method, an inductively coupled plasma (ICP) emission spectral analysis, Raman spectroscopy, energy dispersive X-ray spectrometry (EDX), or the like.

Particularly, when the second lithium composite oxide is analyzed using the XRD method, a peak caused by Li₂MnO₃, and a peak caused by LiMnO₂ are observed. This is because the second lithium composite oxide is present as a solid solution with Li₂MnO₃ and LiMnO₂.

In addition, in regard to the secondary battery, in a region where a charge and discharge is performed (a region where the positive electrode and the negative electrode are opposite to each other), since a crystalline structure of the first and second lithium composite oxides is changed due to the charge and discharge, there is a possibility that the crystalline structure of the first and second lithium composite oxides may not be confirmed through the X-ray diffraction method or the like. However, in a case where a region (not a charged and discharged region) in which the charge and discharge is not performed is present in the positive electrode, it is preferable to perform an element analysis in that region. This is because a crystalline structure before the charge and discharge is maintained in the not charged and discharged region, such that it is possible to analyze a composition of the positive electrode active material regardless of whether or not the charge and discharge is performed. This “not charged and discharged region” includes a region where, for example, an insulating protective tape is attached on a surface of an end portion of the positive electrode (positive electrode active material layer) for securing safety, such that the charge and discharge is not performed between the positive electrode and the negative electrode due to the insulating protective tape.

### Use Condition of Positive Electrode Active Material

In a case where the secondary battery using the positive electrode active material is charged and discharged, it is preferable that a charge voltage (positive electrode potential: vs lithium metal standard potential) during the charge of the first time be 4.5 V or more. This is because during the charge and discharge of the first time, a lithium-rich second lithium composite oxide is preferentially consumed to cause an irreversible capacity of the negative electrode. However, to suppress a decomposition reaction of the second lithium composite oxide, it is preferable that the charge voltage during a charge of the first time be 4.6 V or less.

In addition, a charge voltage during a charge after the first time (positive electrode potential: vs lithium metal standard potential) is not particularly limited, but it is preferable that this charge voltage be lower than the charge voltage during the charge of the first time. Specifically, this charge voltage is, for example, nearly 4.3 V. This is because it is possible to obtain a sufficient energy density by the first lithium composite oxide, and a decomposition reaction of an electrolytic solution, a dissolution reaction of a separator, or the like are suppressed.

### Operation and Effect of Positive Electrode Active Material

This positive electrode active material includes the first lithium composite oxide and the second lithium composite oxide expressed by equation (1). In addition, the charge capacity (vs lithium metal) per unit volume during the charge and discharge of the first cycle is larger in the second lithium composite oxide compared to the first lithium composite oxide, and the discharge voltage (vs lithium metal) during the charge and discharge of the first cycle is lower in the second lithium composite oxide compared to the first lithium composite oxide. In this case, as described above, in regard to a lithium ion secondary battery using the positive electrode active material, when the charge voltage during a charge of the first time (for example, 4.6 V) is made to be larger than the charge voltage (for example, 4.35 V) during a charge after the first time, during the charge and discharge of the first time, an irreversible capacity is compensated for by the second lithium composite oxide and during the charge and discharge after the first time, a high battery capacity may be obtained by the first lithium composite oxide with a high energy density. Therefore, the compensation for the irreversible capacity during the charge and discharge of the first time and the securing of the high energy density during the charge and discharge after the first time may be compatible, such that it is possible to obtain a high battery capacity even when the charge and discharge is repeated.

Particularly, in a case where a material in which the irreversible capacity becomes large is used as the negative electrode active material of the negative electrode 22, it is possible to obtain a relatively high effect. As such a material, a material including at least one of silicon and tin as a constituent element (particularly, a silicon oxide (SiOₓ: 0.2<x<1.4), a carbon material (low crystalline carbon or amorphous carbon), or the like may be exemplified.

### 2. Application Example of Positive Electrode Active Material

Next, an application example of the above-described positive electrode active material will be described. This positive electrode active material is used for, for example, a positive electrode of a lithium ion secondary battery.

### 2-1. Positive Electrode and Lithium Ion Secondary Battery (Cylinder Type)

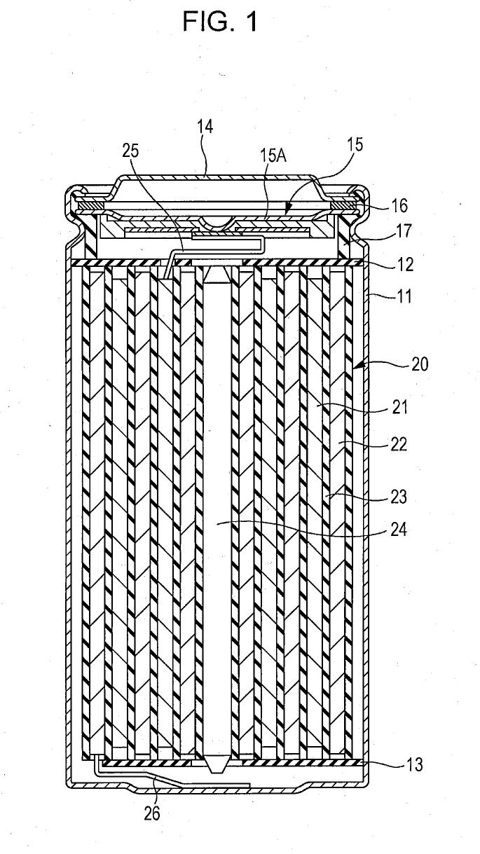

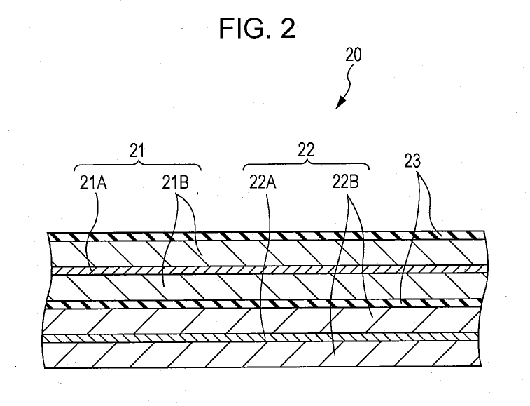

FIGS. 1 and 2 illustrate a cross-sectional configuration of a cylinder type secondary battery, and FIG. 2 illustrates an enlarged part of a wound electrode body 20 shown in FIG. 1.

### Overall Configuration of Secondary Battery

The secondary battery mainly includes the wound electrode body 20 and a pair of insulating plates 12 and 13 which are accommodated inside a hollow columnar battery casing 11. The wound electrode body 20 is a wound laminated body in which a positive electrode 21 and a negative electrode 22 are laminated with a separator 23 interposed therebetween and this laminated body is wound.

The battery casing 11 has a hollow structure in which one end portion is closed and the other end portion is opened, and is formed of, for example, iron, aluminum, an alloy thereof, or the like. In addition, in a case where the battery casing 11 is formed of iron, nickel or the like may be plated on a surface of the battery casing 11. The pair of insulating plates 12 and 13 is disposed so as to extend in a direction orthogonal to a winding circumferential surface with the wound electrode body 20 interposed therebetween in a vertical direction.

At the opened end portion of the battery casing 11, a battery lid 14, a safety valve mechanism 15, and a PTC (positive temperature coefficient) element 16 are caulked through a gasket 17. In this manner, the battery casing 11 is sealed. The battery lid 14 is formed of, for example, the same material as that of the battery casing 11. The safety valve mechanism 15 and the PTC element 16 are provided at an inner side of the battery lid 14, and the safety valve mechanism 15 is electrically connected to the battery lid 14 through the PTC element 16. The safety valve mechanism 15 is configured in such a manner that when an internal pressure becomes a predetermined value or more due to a short circuit, heating from outside, or the like, a disc plate 15A is inverted and the electrical connection between the battery lid 14 and the wound electrode body 20 is disconnected. The PTC element 16 prevents abnormal heat generation caused by a large current through an increase in resistance corresponding to a temperature rising. The gasket 17 is formed of, for example, an insulating material, and asphalt may be applied on a surface thereof.

At a center of the wound electrode body 20, a center pin 24 may be inserted. A positive electrode lead 25 formed of a conductive material such as aluminum is connected to the positive electrode 21, and a negative electrode lead 26 formed of a conductive material such as nickel is connected to the negative electrode 22. The positive electrode lead 25 is connected to the safety valve mechanism 15 through a welding or the like, and is electrically connected to the battery lid 14. The negative electrode lead 26 is connected to the battery casing 11 through a welding or the like, and is electrically connected thereto.

### Positive Electrode

The positive electrode 21 includes a positive electrode current collector 21A and a positive electrode active material layer 21B provided on a surface or both surfaces of the positive electrode current collector 21A. The positive electrode current collector 21A is formed of a conductive material such as aluminum, nickel, and stainless steel. The positive electrode active material layer 21B includes the above described positive electrode active material (first and second lithium composite oxides), and may include another material such as a positive electrode binding agent or a positive electrode conducting agent according to necessity.

The positive electrode binding agent includes any one kind or two kinds or more of synthetic rubber, a polymer material, or the like. The synthetic rubber includes, for example, styrene butadiene-based rubber, fluorine-based rubber, ethylene propylene diene, or the like. The polymer material includes, for example, polyvinylidene fluoride, polyimide, or the like.

The positive electrode conducting agent includes, for example, any one kind or two kinds or more of a carbon material or the like. The carbon material includes, for example, graphite, carbon black, acetylene black, ketjen black, or the like. In addition, the positive electrode conducting agent may be a metallic material, a conductive polymer, or the like as long as this material has conductivity.

### Negative Electrode

The negative electrode 22 includes, for example, a negative electrode current collector 22A and a negative electrode active material 22B provided on one surface or both surfaces of the negative electrode current collector 22A.

The negative electrode current collector 22A is formed of a conductive material such as copper, nickel, and stainless steel. It is preferable that a surface of the negative electrode current collector 22A be roughened. This is because an adhesion property between the negative electrode current collector 22A and the negative electrode active material layer 22B is improved due to a so-called anchor effect. In this case, a region, which is opposite to at least the negative electrode active material layer 22B, in a surface of the negative electrode current collector 22A may be roughened. As a roughening method, for example, a method of forming a particulate material through an electrolytic treatment, or the like may be exemplified. This electrolytic treatment is a method of providing concavities and convexities by forming the particulate material on the negative electrode current collector 22A in an electrolytic bath through an electrolytic method. Copper foil formed through the electrolytic method is generally called electrolytic copper foil.

The negative electrode active material layer 22B includes, as a negative electrode active material, any one kind or two or more kinds of negative electrode materials that can occlude and emit lithium ions, and may include another material such as a negative electrode binding agent and a negative electrode conducting agent according to necessity. In addition, details of the negative electrode binding agent and the negative electrode conducting agent are the same as those of the positive electrode binding agent and the positive electrode conducting agent, for example. In the negative electrode active material layer 22B, it is preferable that a chargeable capacity of the negative electrode material be larger than a discharge capacity of the positive electrode 21 to prevent lithium metal from being precipitated unintentionally during a charge and discharge.

The negative electrode material includes, for example, a carbon material. This is because variation in a crystalline structure during occluding and emitting of lithium ions is very small, and therefore it is possible to obtain a high energy density and excellent cycle characteristics. In addition, this is because the carbon material also functions as the negative electrode conducting agent. As the carbon material, for example, easy-graphitization carbon, non-graphitization carbon in which a plane spacing of (002) plane is 0.37 nm or more, graphite in which a plane spacing of (002) plane is 0.34 nm or less, or the like may be exemplified. More specifically, pyrolytic carbon, coke, glassy carbon fiber, organic polymer compound baked body, activated charcoal, carbon black, or the like may be exemplified. Among these, as the coke, pitch coke, needle coke, petroleum coke, or the like may be exemplified. In regard to a carbon material other than phenol, the organic polymer compound baked body may include low crystalline carbon or amorphous carbon that is subjected to a heat treatment at a temperature of approximately 1000° C. or less, and represents a polymer material such as a phenol resin and a furan resin that is baked in an appropriate high temperature and carbonized. The organic polymer compound baked body represents a polymer material obtained by baking and carbonizing a resin or a furan resin in an appropriate high temperature. In addition to this, the carbon material may be low crystalline carbon or amorphous carbon that is subjected to a heat treatment at a temperature of 1000° C. or less. In addition, a form of the carbon material may be a fiber shape, a spherical shape, a powder form, or a squamous form.

In addition, the negative electrode material is a material (metal-based material) including any one kind or two or more kinds of a metal element and a metalloid element as a constituent element. This is because a high energy density may be obtained. This metal-based material may be an elementary substance of the metal element or metalloid element, an alloy or a compound thereof, or two kinds or more of these. Furthermore, at least a part of the metal-based material may include one kind or two kinds or more of these. In addition, the alloy according to an embodiment of the present disclosure also includes a material including one kind or more of metal elements and one kind or more of metalloid elements in addition to a material including two or more kinds of metal elements. The alloy may include non-metal elements. A solid solution, eutectic (eutectic mixture), an intermetallic compound, two kinds or more of coexisting materials thereof, or the like are present in a structure of the alloy.

The above-described metal element or metalloid element is a metal element or metalloid element that can form an alloy together with, for example, lithium, and specifically, includes one kind or two kinds or more of the following elements: magnesium, boron, aluminum, gallium, indium, silicon, germanium (Ge), tin, lead (Pb), bismuth (Bi), cadmium (Cd), silver (Ag), zinc, hafnium (Hf), zirconium, yttrium, palladium (Pd), or platinum (Pt). Among these, it is preferable to include at least one of silicon and tin. This is because silicon and tin have an excellent capability of occluding and emitting lithium ions, such that a high energy density may be obtained.

A material including at least one of silicon and tin may be an elementary substance of silicon or tin, an alloy or a compound thereof, or two kinds or more of these. Furthermore, at least a part of the metal-based material may include one kind or two kinds or more of these. In addition, the “elementary substance” means a “substantially elementary substance,” and does not mean to have a purity of 100%.

The alloy of silicon includes a material including one kind or two kinds or more of the following elements as a constituent element other than silicon: tin, nickel, copper, iron, cobalt, manganese, zinc, indium, silver, titanium, germanium, bismuth, antimony, or chromium. As the compound of silicon, for example, a compound including oxygen or carbon as a constituent element other than silicon may be exemplified. In addition, the compound of silicon may include, for example, one kind or two kinds or more of elements described above with respect to the alloy of silicon as a constituent element other than silicon.

The alloy or compound of silicon includes, for example, the following materials or the like: SiB₄, SiB₆, Mg₂Si, Ni₂Si, TiSi₂, MoSi₂, CoSi₂, NiSi₂, CaSi₂, CrSi₂, Cu₅Si, FeSi₂, MnSi₂, NbSi₂, TaSi₂, VSi₂, WSi₂, ZnSi₂, SiC, Si₃N₄, Si₂N₂O, SiOᵥ (0<v≦2), or LiSiO. In addition, in SiOᵥ, v may be in a range of 0.2<v<1.4.

The alloy of tin includes a material including one kind or two kinds or more of the following elements as a constituent element other than tin: silicon, nickel, copper, iron, cobalt, manganese, zinc, indium, silver, titanium, germanium, bismuth, antimony, or chromium. As the compound of tin, for example, a material including oxygen or carbon as a constituent element may be exemplified. In addition, the compound of tin may include, for example, one kind or two kinds or more of elements described above with respect to the alloy of tin as a constituent element other than tin. As the alloy or compound of tin, for example, SnO, (0<w≦2), SnSiO₃, LiSnO, Mg₂Sn, or the like may be exemplified.

In addition, as the material including tin, for example, a material, which includes tin as a first constituent element and includes second and third constituent elements, is preferable. The second constituent element includes, for example, one kind or two kinds or more of the following elements: cobalt, iron, magnesium, titanium, vanadium, chromium, manganese, nickel, copper, zinc, gallium, zirconium, niobium, molybdenum, silver, indium, cerium (Ce), hafnium, tantalum, tungsten (W), bismuth, or silicon. The third constituent element includes, for example, one kind or two kinds or more of boron, carbon, aluminum, and phosphorus. When the material includes the second and third constituent elements, it is possible to obtain a high battery capacity and excellent cycle characteristics, such that this material is preferable.

Among these, a material (SnCoC-containing material) including tin, cobalt, and carbon is preferable. As a composition of the SnCoC-containing material, for example, there is a composition in which a content of carbon is 9.9 to 29.7 mass %, and a ratio (Co/(Sn+Co)) of a content of tin and a content of cobalt is 20 to 70 mass %. This is because within this composition range, a high energy density may be obtained.

This SnCoC-containing material has a phase including tin, cobalt, and carbon, and it is preferable that the phase have a low crystalline structure or an amorphous structure. This phase is a reaction phase that can react with lithium, and it is possible to obtain an excellent characteristic due to the presence of the reaction phase. It is preferable that a half width of a diffraction peak that can be obtained by an X-ray diffraction be 1.0° or more at a diffraction angle 2θ in a case where CuKα rays are used as specific X-rays and a sweeping velocity is set to 1.0°/min. This is because lithium ions are relatively smoothly occluded and emitted, and a reaction property of the lithium ions with an electrolytic solution decreases. In addition, the SnCoC-containing material may have a phase including an elementary substance or a part of each constituent element in addition to the low crystalline phase or the amorphous phase.

It is possible to easily determine whether or not a diffraction peak that can be obtained by X-ray diffraction corresponds to the reaction phase that can react with lithium by comparing X-ray diffraction charts before and after an electrochemical reaction with lithium. For example, in a case where the diffraction peak varies before and after the electrochemical reaction with lithium, this corresponds to the reaction phase that can react with lithium. In this case, for example, the diffraction peak of the low crystalline or amorphous reaction phase is shown in a range of 2θ=20° to 50°. This is considered to be because the reaction phase includes, for example, each constituent element described above, and is crystallized to a low degree or becomes amorphous due to the presence of carbon.

In the SnCoC-containing material, it is preferable that at least a part of carbon that is a constituent element couple with a metal element or a metalloid element. This is because agglomeration or crystallization of tin or the like is suppressed. It is possible to confirm a coupling state of elements through X-ray photoelectron spectroscopy (XPS). In an apparatus available in the market, for example, as soft X-rays, Al-Kα rays, Mg-Kα rays, or the like are used. In a case where at least a part of carbon is coupled with a metal element, metalloid element, or the like, a peak of a synthetic wave of the is orbital (C1s) of carbon appears at a region lower than 284.5 eV. In addition, it is assumed that an energy correction is performed such that a peak of the 4f orbital (Au4f) of gold is obtained at 84.0 eV. At this time, commonly, surface contamination carbon is present on a material surface, such that a peak of C1s of carbon is set to 284.8 eV, and this is made as an energy reference. In an XPS measurement, a waveform of a peak of C1s is obtained in a shape including a peak of the surface contamination carbon and a peak of carbon in the SnCoC-containing material, such that, for example, analysis is performed using software available in the market and both peaks are separated. In analysis of a waveform, a location of a main peak that is present at the side of the lowest binding energy is set as an energy reference (284.8 eV).

In addition, the SnCoC-containing material may further include another constituent element. As this another constituent element, one kind or two kinds or more of silicon, iron, nickel, chromium, indium, niobium, germanium, titanium, molybdenum, aluminum, phosphorous, gallium, and bismuth may be exemplified.

A material containing tin, cobalt, iron, and carbon (SnCoFeC-containing material) other than the SnCoC-containing material is also preferable. A composition of this SnCoFeC-containing material may be arbitrary set. For example, in a case where a content of iron is set to be small, the composition is as follows. A content of carbon is 9.9 to 29.7 mass %, a content of iron is 0.3 to 5.9 mass %, a ratio (Co/(Sn+Co)) of a content of tin and a content of cobalt is 30 to 70 mass %. In addition, for example, in a case where a content of iron is set with an extra amount, a composition thereof is as follows. A content of carbon is 11.9 to 29.7 mass %. In addition, a ratio ((Co+Fe)/(Sn+Co+Fe)) of a content of tin, a content of cobalt, and a content of iron is 26.4 to 48.5 mass %, and a ratio (Co/(Co+Fe)) of a content of cobalt and a content of iron is 9.9 to 79.5 mass %. This is because within this composition range, a high energy density may be obtained. A physical property (half width or the like) of the SnCoFeC-containing material is the same as that of the above-described SnCoC-containing material.

In addition, as a material of the negative electrode, a metal oxide, a polymer compound, or the like may be exemplified. As the metal oxide, for example, an iron oxide, a ruthenium oxide, a molybdenum oxide, or the like may be exemplified. As the polymer compound, for example, polyacetylene, polyaniline, polypyrrole, or the like may be exemplified.

The negative electrode active material layer 22B may be formed through, for example, an application method, a gas phase method, a liquid phase method, a thermal spraying method, a baking method (sintering method), or two kinds or more thereof. The application method is a method in which a particulate negative electrode active material is mixed with a binding agent or the like, the resultant mixture is dispersed in a solvent such as an organic solvent, and the resultant dispersed solution is applied. As the vapor phase method, for example, a physical deposition method, a chemical deposition method, or the like may be exemplified. Specifically, a vacuum deposition method, a sputtering method, an ion plating method, a laser ablation method, a thermal chemical vapor deposition, a chemical vapor deposition (CVD) method, a plasma chemical vapor deposition method, or the like may be exemplified. As the liquid phase method, an electroplating, an electroless plating, or the like may be exemplified. The thermal spraying method is a method in which the negative electrode active material is sprayed in a molten state or a semi-molten state. The baking method is a method in which application is performed by the same sequence as that of the application method, and then a heat treatment at a temperature higher than that of the binding agent or the like is performed. In regard to the baking method, an existing method may be used, and, for example, an atmospheric baking method, a reaction baking method, a hot press baking method, or the like may be exemplified.

### Separator

The separator 23 isolates the positive electrode 21 and the negative electrode 22, and allows lithium ions to pass therethrough while preventing a short circuit of a current caused by a contact between both electrodes. An electrolyte (electrolytic solution) is impregnated in the separator 23. The separator 23 is formed of a porous film or the like including, for example, a synthetic resin or ceramic, and may have a structure in which two kinds or more of these porous films are laminated. As the synthetic resin, for example, polytetrafluoroethylene, polypropylene, or polyethylene, or the like may be exemplified.

### Electrolyte

This electrolyte includes a solvent, and an electrolytic salt that is dissolved in the solvent.

The solvent includes, for example, one kind or two kinds or more of the following nonaqueous solvents (organic solvents): ethylene carbonate, propylene carbonate, butylene carbonate, dimethyl carbonate, diethyl carbonate, ethyl methyl carbonate, methyl propyl carbonate, γ-butyrolactone, γ-valerolactone, 1,2-dimethoxyethane, tetrahydrofuran, 2-methyltetrahydrofuran, tetrahydropyran, 1,3-dioxolane, 4-methyl-1,3-dioxolane, 1,3-dioxane, 1,4-dioxane, methyl acetate, ethyl acetate, methyl propionate, ethyl propionate, methyl butyrate, methyl isobutyrate, methyl trimethyl acetate, ethyl trimethyl acetate, acetonitrile, glutaronitrile, adiponitrile, methoxyacetonitrile, 3-methoxypropionitrile, N,N-dimethylformamide, N-methylpyrrolidinone, N-methyloxazolidinone, N,N′-dimethylimidazolidinone, nitromethane, nitroethane, sulfolane, trimethyl phosphate, or dimethyl sulfoxide. This is because an excellent battery capacity, excellent cycle characteristics, and excellent storage characteristics may be obtained.

Among these, at least one kind selected among ethylene carbonate, propylene carbonate, dimethyl carbonate, diethyl carbonate, and ethyl methyl carbonate is preferable. This is because relatively excellent characteristics may be obtained. In this case, a combination of a solvent having high viscosity (high dielectric constant) (for example, specific dielectric constant ∈≧30) such as ethylene carbonate and propylene carbonate, and a solvent having low viscosity (for example, viscosity ≦1 mPa·s) such as dimethyl carbonate, ethyl methyl carbonate, and diethyl carbonate may be used. This is because dissociation of the electrolyte salt and mobility of an ion are improved.

Particularly, the solvent may be cyclic carboxylic acid ester (unsaturated carbon bond cyclic carboxylic acid ester) having one or two or more unsaturated carbon bonds. This is because during a charge and discharge, a stable protective film is formed on a surface of the negative electrode 22, such that a decomposition reaction of the electrolyte is suppressed. As the unsaturated carbon bond cyclic carboxylic acid ester, for example, vinylene carbonate, vinyl ethylene carbonate, or the like may be exemplified. In addition, a content of the unsaturated carbon bond cyclic carboxylic acid ester in a nonaqueous solvent is, for example, 0.01 to 10 wt %. This is because a battery capacity is not decreased so much, and a decomposition reaction of the electrolyte is suppressed.

In addition, the solvent may be at least one kind of chain carboxylic acid ester (halogenated chain carbonic acid ester) having one or two or more of halogen groups, and cyclic carboxylic acid ester (halogenated cyclic carboxylic acid ester) having one or two or more halogen groups. This is because during a charge and discharge, a stable protective film is formed on a surface of the negative electrode 22, such that a decomposition reaction of the electrolyte is suppressed. Kinds of the halogen groups are not particularly limited, but among these, a fluorine group, a chlorine group, or a bromine group is preferable, and the fluorine group is more preferable. This is because a high effect may be obtained. However, as the number of halogen groups, two is preferable rather than one, and the number of halogen groups may be three or more. This is because a relatively strong and stable protective film is formed, such that a decomposition reaction of the electrolyte is more suppressed. As the halogenated chain carboxylic acid ester, for example, fluoromethyl methyl carbonate, bis(fluoromethyl) carbonate, difluoromethyl methyl carbonate, or the like may be exemplified. As the halogenated cyclic carboxylic acid ester, 4-fluoro-1,3-dioxolane-2-one, 4,5-difluoro-1,3-dioxolane-2-one, or the like may be exemplified. In addition, a content of the halogenated chain carbonic ester and the halogenated cyclic carbonic ester in a nonaqueous solvent is, for example, 0.01 to 50 wt %. This is because a battery capacity is not decreased so much, and a decomposition reaction of the electrolyte is suppressed.

In addition, the solvent may be a sultone (cyclic sulfonic acid ester). This is because a chemical target stability of the electrolytic solution is improved. As the sultone, for example, propane sultone, propene sultone, or the like may be exemplified. In addition, a content of the sultone in a nonaqueous solvent is, for example, 0.5 to 5 wt %. This is because a battery capacity is not decreased so much, and a decomposition reaction of the electrolyte is suppressed.

In addition, the solvent may be an acid anhydride. This is because the chemical target stability of the electrolytic solution is more improved. As the acid anhydride, for example, dicarboxylic acid anhydride, disulfonic acid anhydride, carboxylic acid sulfonic acid anhydride, or the like may be exemplified. As the dicarboxylic acid anhydride, for example, succinic anhydride, glutaric anhydride, maleic anhydride, or the like may be exemplified. As the disulfonic acid anhydride, for example, ethane sulfonic anhydride, propane disulfonic anhydride, or the like may be exemplified. As the carboxylic acid anhydride, for example, sulfobenzoic acid anhydride, sulfopropionic acid anhydride, sulfobutyric acid anhydride, or the like may be exemplified. In addition, a content of the acid anhydride in a nonaqueous solvent is, for example, 0.5 to 5 wt %. This is because a battery capacity is not decreased so much, and a decomposition reaction of the electrolyte is suppressed.

Electrolyte Salt

An electrolyte salt is one kind or two or more kinds of lithium salt described later. However, the electrolyte salt may be another salt (for example, light metal salt) other than the lithium salt.

As the lithium salt, for example, the following compounds or the like may be exemplified: lithium hexafluorophosphate (LiPF₆), lithium tetrafluoroborate (LiBF₄), lithium perchlorate (LiClO₄), lithium hexafluoroarsenate (LiAsF₆), lithium tetraphenylborate (LiB(C₆H₅)₄), lithium methanesulfonate (LiCH₃SO₃), lithium trifluoromethanesulfonate (LiCF₃SO₃), lithium tetrachloroaluminate (LiAlCl₄), lithium hexafluorosilicate Li₂SiF₆), lithium chloride (LiCl), or lithium bromide (LiBr). This is because an excellent battery capacity, excellent cycle characteristics, and excellent storage characteristics may be obtained.

Among these, at least one of lithium hexafluorophosphate, lithium tetrafluoroborate, lithium perchlorate, and lithium hexafluoroarsenate is preferable, and lithium hexafluorophosphate is more preferable. This is because an internal resistance decreases, such that a relatively high effect may be obtained.

It is preferable that a content of the electrolyte salt be 0.3 to 3.0 mol/kg with respect to a solvent. This is because high ion conductivity may be obtained.

### Operation of Secondary Battery

In this secondary battery, for example, during a charge, lithium ions emitted from the positive electrode 21 are occluded in the negative electrode 22 through an electrolytic solution. In addition, for example, during a discharge, lithium ions emitted from the negative electrode 22 are occluded in the positive electrode 21 through the electrolytic solution. In this case, as described above, it is preferable that a charge voltage (for example, 4.6 V) during a charge of the first time be set to be higher than a charge voltage (4.35 V) during a charge after the first time for compensating an irreversible capacity occurring at the negative electrode 22 by the second lithium composite oxide during the charge and discharge of the first time.

### Method of Manufacturing Secondary Battery

This secondary battery is manufactured, for example, by the following sequence.

First, the positive electrode 21 is manufactured. At first, a positive electrode active material (first and second lithium composite oxides), and a positive electrode binding agent, a positive electrode conducting agent, or the like, as necessary, are mixed to produce a paste-type positive electrode mixture. Then, this positive electrode mixture is dispersed in an organic solvent or the like and thereby a positive electrode mixture slurry is obtained. Subsequently, this positive electrode mixture slurry is applied onto both surfaces of the positive electrode current collector 21A and is dried, and thereby the positive electrode active material layer 21B is formed. Finally, the positive electrode current collector layer 21B is compression-molded by a roll pressing machine or the like while being heated according to necessity. In this case, this compression molding may be performed plural times.

Next, the negative electrode 22 is manufactured in the same sequence as that of the positive electrode 21. In this case, a negative electrode active material, and a negative electrode binding agent, a negative electrode conducting agent, or the like, as necessary, are mixed to produce a negative electrode mixture. Then, this negative electrode mixture is dispersed in an organic solvent or the like and thereby a paste-type negative electrode mixture slurry is obtained. Subsequently, this negative electrode mixture slurry is applied onto both surfaces of the negative electrode current collector 22A and is dried, and thereby the negative electrode active material layer 22B is formed. Then, the negative electrode active material layer 22B is compression-molded according to necessity.

In addition, the negative electrode 22 may be manufactured by a sequence different from the sequence in the positive electrode 21. In this case, for example, a negative electrode material is deposited on both surfaces of the negative electrode current collector 22A by using a vapor phase method such a deposition method, and thereby the negative electrode active material layer 22B is formed.

Finally, a secondary battery is assembled using the positive electrode 21 and the negative electrode 22. First, the positive electrode lead 25 is attached to the positive electrode current collector 21A through a welding or the like, and the negative electrode lead 26 is attached to the negative electrode current collector 22A through a welding or the like. Subsequently, the positive electrode 21 and the negative electrode 22 are laminated with the separator 23 interposed therebetween, and are wound to form the wound electrode body 20. Then, the center pin 24 is inserted into the wound electrode body 20 at a winding center thereof. Subsequently, the wound electrode body 20 is accommodated inside the battery casing 11 while being interposed between the pair of insulating plates 12 and 13. In this case, a front end portion of the positive electrode lead 25 is attached to the safety valve mechanism 15 through a welding or the like, and a front end portion of the negative electrode lead 26 is attached to the battery casing 11 through a welding or the like. Subsequently, an electrolytic solution is injected into the inside of the battery casing 11, and is impregnated in the separator 23. Finally, the battery lid 14, the safety valve mechanism 15, and the PTC element 16 are caulked to an opening end portion of the battery casing 11 with the gasket 17 interposed therebetween. In this manner, a secondary battery shown in FIGS. 1 and 2 is manufactured.

### Operation and Effect of Secondary Battery

According to this cylinder type secondary battery, the positive electrode active material layer 21B of the positive electrode 21 includes the above-described positive electrode active material (first and second lithium composite oxides). Therefore, as described above, when a charge voltage during a charge of the first time is set to be higher than a charge voltage during a charge after the first time, a compensation for the irreversible capacity during a charge and discharge of the first time and a securing of a high energy density during a charge and discharge after the first time are compatible. Therefore, even when the charge and discharge is repeated, a high battery capacity may be stably obtained.

Particularly, in a case where a material in which the irreversible capacity becomes large is used as the negative electrode active material of the negative electrode 22, it is possible to obtain a relatively high effect. As such a material, a material including at least one of silicon and tin as a constituent element (particularly, a silicon oxide (SiOₓ: 0.2<x<1.4)), a low crystalline carbon material or the like may be exemplified.

### 2-2. Positive Electrode and Lithium Ion Secondary Battery (Laminated Film Type)

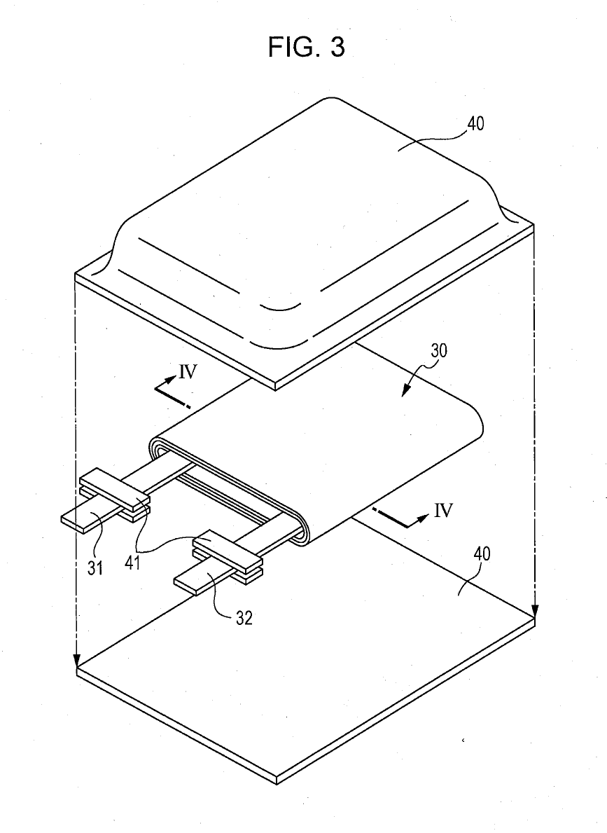

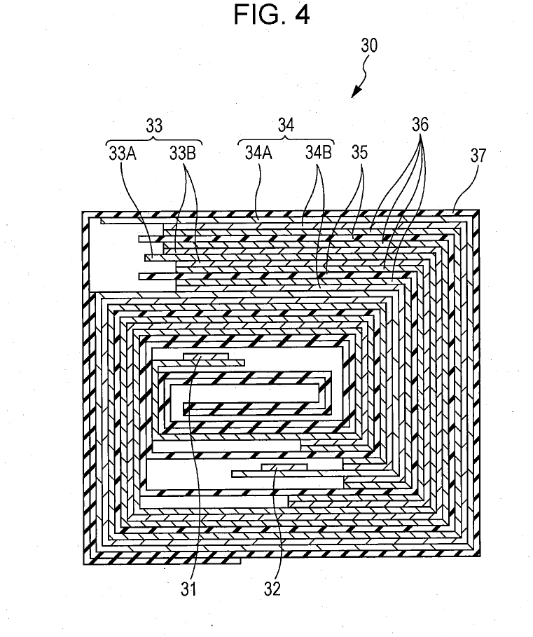

FIG. 3 shows an exploded perspective view of a laminated film type lithium ion secondary battery, and FIG. 4 shows an exploded view taken along a line IV-IV of a wound electrode body 30 shown in FIG. 3. Hereinafter, components of the cylinder type lithium ion secondary battery described above will be frequently referred.

### Entire Configuration of Secondary Battery

This secondary battery has a main configuration in which the wound electrode body 30 is accommodated in a film-shaped exterior member 40. This wound electrode body 30 is configured in such a manner that a positive electrode 33 and a negative electrode 34 are laminated with a separator 35 and an electrolyte layer 36 interposed therebetween and this laminated body is wound. A positive electrode lead 31 is attached to the positive electrode 33, and a negative electrode lead 32 is attached to the negative electrode 34. The outermost peripheral portion of the wound electrode body 30 is protected by a protective film 37.

For example, the positive electrode lead 31 and the negative electrode lead 32 lead out from the inside of the exterior member 40 toward the outside in the same direction. The positive electrode lead 31 is formed of, for example, a conductive material such as aluminum, and the negative electrode lead 32 is formed of, for example, a conductive material such as copper, nickel, and stainless steel. This material has, for example, a thin plate shape or a network shape.

The exterior member 40 is a laminated film in which, for example, a fusion layer, a metallic layer, and a surface protecting layer are laminated in this order. In this laminated film, for example, fusion layers of two sheets of films are adhered to each other in an external periphery through a fusion or by an adhesive or the like in such a manner that the fusion layer is opposite to the wound electrode body 30. The fusion layer is formed of, for example, a film of polyethylene, polypropylene, or the like. The metallic layer is formed of, for example, aluminum foil. The surface protecting layer is formed of, for example, a film of nylon, polyethylene terephthalate, or the like.

Among these, as the exterior member 40, an aluminum laminated film in which the polyethylene film, aluminum foil, and the nylon film are laminated in this order is preferable. However, the exterior member 40 may be formed by a laminated film having another lamination structure, a polymer film such as polypropylene, or a metallic film.

An adhesive film 41 is inserted between the exterior members 40 and the positive electrode lead 31 and the negative electrode lead 32 to prevent the penetration of outside air. This adhesive film 41 is formed of a material having an adhesion property with respect to the positive electrode lead 31 and the negative electrode lead 32. As this material, a polyolefin resin such as polyethylene, polypropylene, modified polyethylene, modified polypropylene, or the like may be exemplified.

The positive electrode 33 includes a positive electrode current collector 33A and a positive electrode active material layer 33B provided on both surfaces of the positive electrode current collector 33A. The negative electrode 34 includes a negative electrode current collector 34A and a negative electrode active material layer 34B provided on both surfaces of the negative electrode current collector 34A. The configurations of the positive electrode current collector 33A, the positive electrode active material layer 33B, the negative electrode current collector 34A, and the negative electrode active material layer 34B are the same as those of the positive electrode current collector 21A, the positive electrode active material layer 21B, the negative electrode current collector 22A, and the negative electrode active material layer 22B. In addition, a configuration of the separator 35 is the same as that of the separator 23.

In the electrolyte layer 36, an electrolytic solution formed of a polymer compound is maintained, and the electrolyte layer 36 may include another material such as an addictive if necessary. This electrolyte layer 36 is a so-called gel type electrolyte. This gel type electrolyte is preferable. This is because high ion conductivity (for example, 1 mS/cm or more at room temperature) may be obtained and a leakage of the electrolytic solution is prevented.

The polymer compound includes any one kind or two kinds or more of the following polymer materials or the like: polyacrylonitrile, polyvinylidene fluoride, polytetrafluoroethylene, polyhexafluoropropylene, polyethylene oxide, polypropylene oxide, polyphosphazene, polysiloxane, polyvinyl fluoride, polyvinyl acetate, polyvinyl alcohol, polymethylmethacrylate, polyacrylate, polymethacrylate, styrene-butadiene rubber, nitrile butadiene rubber, polystyrene, polycarbonate, and a copolymer of vinylidene fluoride and hexafluoropyrene. Among these, polyvinylidene fluoride or the copolymer of vinylidene fluoride and hexafluoropyrene are preferable. This is because these are electrochemically stable.

A composition of the electrolytic solution is the same as that of the electrolyte described with respect to the cylinder type. However, in regard to the electrolyte layer 36 that is a gel-type electrolyte, the nonaqueous solvent of the electrolytic solution includes not only a liquid solvent but also a material having an ion conductivity that can dissociate the electrolyte salt. Therefore, in the case of using the polymer compound having the ion conductivity, the polymer compound is also included in the solvent.

In addition, instead of the gel-type electrolyte layer 36, the electrolytic solution may be used as is. In this case, the electrolytic solution is impregnated in the separator 35.

### Operation of Secondary Battery

In this secondary battery, for example, during a charge, lithium ions emitted from the positive electrode 33 are occluded in the negative electrode 34 through the electrolyte layer 36. In addition, for example, during a discharge, lithium ions emitted from the negative electrode 34 are occluded in the positive electrode 33 through the electrolyte layer 36.

### Method of Manufacturing Secondary Battery

The secondary battery including the gel-type electrolyte layer 36 is manufactured, for example, in the following three kinds of sequences.

In a first sequence, first, the positive electrode 33 and the negative electrode 34 are manufactured by the same sequence of the positive electrode 21 and the negative electrode 22. In this case, the positive electrode active material layer 33B is formed at both surfaces of the positive electrode current collector 33A and thereby the positive electrode 33 is manufactured, and the negative electrode active material layer 34B is formed at both surfaces of the negative electrode current collector 34A, and thereby the negative electrode 34 is manufactured. Subsequently, a precursor solution including an electrolytic solution, a polymer compound, and a solvent such as an organic solvent is prepared. This precursor solution is applied on the positive electrode 33 and the negative electrode 34, and thereby the gel-type electrolyte layer 36 is formed. Subsequently, the positive electrode lead 31 is attached to the positive electrode current collector 33A through a welding or the like, and the negative electrode lead 32 is attached to the negative electrode current collector 34A through a welding or the like. Subsequently, the positive electrode 33 and the negative electrode 34 to which the electrolyte layer 36 is provided, respectively, are laminated with the separator 35 interposed therebetween, and are wound to form the wound electrode body 30. Then, a protective tape 37 is adhered to the outermost peripheral portion of the wound electrode body 30. Finally, the wound electrode body 30 is interposed between two sheets of film-shaped exterior members 40 and the peripheries of the exterior members 40 are bonded to each other through thermal fusion or the like to seal the wound electrode body 30 in the exterior members 40. In this case, an adhesive film 41 is interposed between the positive electrode and negative electrode leads 31 and 32 and the exterior members 40.

In a second sequence, first, the positive electrode lead 31 is attached to the positive electrode 33, and the negative electrode lead 32 is attached to the negative electrode 34. Subsequently, the positive electrode 33 and the negative electrode 34 are laminated with the separator 35 interposed therebetween and this laminated body is wound to manufacture a wound body that is a precursor of the wound electrode body 30. Then, the protective tape 37 is adhered to the outermost peripheral portion of the wound body. Subsequently, the wound body is interposed between two sheets of film-shaped exterior members 40 and the peripheries of the exterior members 40 are bonded to each other through a thermal fusion or the like with one side left to accommodate the wound electrode body 30 in the exterior members 40 having a bag shape. Subsequently, an electrolyte composition including an electrolytic solution, monomers that are a raw material of a polymer compound, a polymerization initiating agent, and other material such as a polymerization prohibiting agent according to necessity is prepared, and this electrolyte composition is injected into the bag-shaped exterior members 40. An opening portion of the exterior members 40 is sealed through thermal fusion. Finally, the monomers are thermally polymerized to form a polymer compound, and thereby the gel-type electrolyte layer 36 is formed.

In a third sequence, first, a wound body is manufactured in the same sequence as that in the second sequence except that the separator 35 to which a polymer compound is applied on both surfaces thereof is used. Then, the wound body is accommodated in the bag-shaped exterior members 40. As the polymer compound applied to the separator 35, a polymer (homopolymer, copolymer, multi-component copolymer, or the like) including vinylidene fluoride as a component may be exemplified. Specifically, polyvinylidene fluoride, a binary copolymer including vinylidene fluoride and hexafluoropropylene as a component, a ternary copolymer including vinylidene fluoride, hexafluoropropylene, and chlorotrifluoroethylene as a component, or the like may be exemplified. In addition, another one kind or two kinds or more of polymer compounds may be used together with a polymer including vinylidene fluoride as a component. Consequently, an electrolytic solution is prepared and is injected into the inside of the exterior members 40. Then, the opening portion of the exterior members 40 is sealed through thermal fusion or the like. Finally, the exterior members 40 are heated while a load is applied thereto, and the separator 35 is brought into close contact with the positive electrode 33 and the negative electrode 34 with a polymer compound interposed therebetween. In this manner, the electrolytic solution is impregnated in the polymer compound, and gelation occurs in the polymer compound and thereby the electrolyte layer 36 is formed.

In this third sequence, a swelling of a battery is suppressed compared to the first sequence. In addition, in this third sequence, almost none of the monomer, the solvent, or the like that are raw materials of the polymer compound remain in the electrolyte layer 36, such that a forming process of the polymer compound may be effectively controlled. Therefore, it is possible to obtain a sufficient adhesion property between the positive electrode 33, the negative electrode 34, and the separator 35, and the electrolyte layer.

### Operation and Effect of Secondary Battery

According to the laminated film type secondary battery, the positive electrode active material layer 33B of the positive electrode 33 includes the above-described positive electrode active material (first and second lithium composite oxides), such that it is possible to obtain a high battery capacity even when the charge and discharge is repeated. Other operations and effects are the same as those in the cylinder type.

### 3. Use of Lithium Ion Secondary Battery

Next, an application example of the above-described lithium ion secondary battery will be described.

This use of the secondary battery is not particularly limited as long as this secondary battery can be used as a power source for driving or a power storage source for storing power in a machine, an apparatus, instrument, a device, or a system (assembly of a plurality of apparatuses or the like). In a case where the secondary battery is used a power source, this power source may be a main power source (a power source that is preferentially used), or an auxiliary power source (a power source that is used instead of the main power source, or a power source that is used by being switched from the main power source). A kind of the main power source is not limited to the secondary battery.

As the use of the secondary battery, for example, the following use or the like may be exemplified: a portable electronic apparatus such as a video camera, a digital still camera, a mobile telephone, a notebook PC, a wireless telephone, a headphone stereo, a portable radio, a portable television, and a portable PDA (personal digital assistant), a household electric apparatus such as an electric shaver, a storage device such as a backup power source and a memory card, an electric tool such as an electric drill and an electric slicer, a medical electronic apparatus such as a pacemaker or a hearing aid, an electric vehicle (including a hybrid vehicle), and a power storage system such as a household battery system that stores power for an emergency.

Among these, the secondary battery is effective for the application to the electric tool, the electric vehicle, the power storage system, or the like. This is because excellent characteristics are necessary with respect to the secondary battery, and it is possible to effectively realize an improvement in characteristics by using the secondary battery according to an embodiment of the present disclosure. In addition, in regard to the electric tool, a moving part (for example, a drill or the like) is driven by using the secondary battery as a driving power source. The electric vehicle operates (runs) by using the secondary battery as a driving power source, and may be a vehicle (a hybrid vehicle or the like) that is also provided with another driving source in addition to the secondary battery. The power storage system is a system using the secondary battery as a power storage source. For example, in a household power storage system, a power is stored in the secondary battery that is a power storage source and the power stored in the secondary battery is consumed according to necessity.

### EXAMPLES

Hereinafter, specific examples of the present disclosure will be described.

### Experiment Examples 1-1 to 1-16

### Synthesis of Positive Electrode Active Material

First and second lithium composite oxides that are positive electrode active materials were obtained by the following sequence.

First, the first lithium composite oxide shown in Table 1 was synthesized. In this case, lithium carbonate (Li₂CO₃) powder and cobalt carbonate (CoCO₃) powder that are raw materials were mixed in a mole ratio of Li:Co=1:1, and the resultant mixture was heated at 900° C. for five hours in the atmosphere to obtain LiCoO₂.

Furthermore, LiNi_{0.8}Co_{0.18}Al_{0.02}O₂ was synthesized by the same sequence as the above-described sequence except that a nickel oxide (NiO) powder and an aluminum oxide (Al₂O₃) powder as a raw material were further mixed in a mole ratio shown in Table 1.

Next, the second lithium composite oxide shown in Table 2 was synthesized. In this case, each powder of lithium carbonate (Li₂CO₃), manganese carbonate (MnCO₃), cobalt hydroxide (Co(OH)₂), nickel hydroxide (Ni(OH)₂) were mixed in a mole ratio of Li:Mn:Co:Ni=1.13:0.6:0.2:0.2, and the resultant mixture was crushed through a ball milling using water as a dispersion medium. Consequently, the mixed powder after being crashed was heated at a high temperature of 850° C. for 12 hours to synthesize Li_{1.13}(Mn_{0.6}Co_{0.2}Ni_{0.2})_{0.87}O₂. With respect to this composition, an atomic ratio was confirmed using an ICP emission spectral analysis.

Furthermore, Li_{1.13}[Mn_{0.5}Co_{0.3}Ni_{0.2}]_{0.87}O₂ or the like were synthesized in the same sequence as the above-described sequence except that a mixing ratio of a raw material was changed such that a mole ratio of Li, Mn, Co, and Ni became a mole ratio shown in Table 2. In this case, a composition (atomic ratio) was confirmed using an ICP emission spectral analysis.

Characteristics of these positive electrode active materials (first and second lithium composite oxide) and a lithium ion secondary battery using these positive electrode active materials were investigated and results shown in Tables 1 to 3 were obtained.

### Measurement of Characteristics of Positive Electrode Active Material

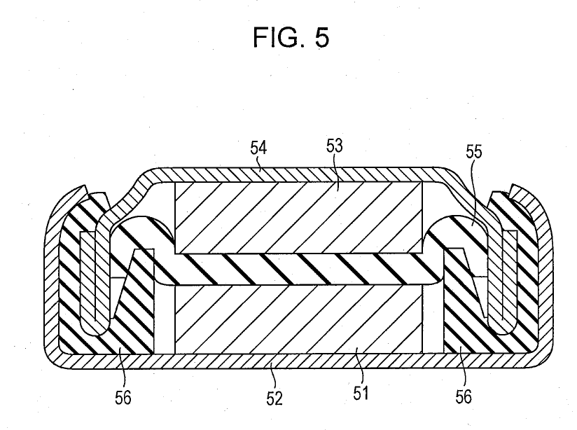

To investigate characteristics of the first lithium composite oxide, a coin type lithium ion secondary battery shown in FIG. 5 was manufactured. This secondary battery was obtained in such a manner that a test electrode 51 using a positive electrode active material was accommodated in a exterior casing 52, a counter electrode 53 was attached to an exterior cup 54, and then the exterior casing 52 and the exterior cup 54 were laminated with a separator 55 in which an electrolytic solution was impregnated interposed therebetween, and were closed with a gasket 56 interposed therebetween.

In the case of manufacturing the test electrode 51, 96 parts by mass of a positive electrode active material (first lithium composite oxide), 3 parts by mass of a positive electrode binding agent (polyvinylidene fluoride: PVDF), and 1 part by mass of a positive electrode conducting agent (carbon black) were mixed, and the resultant mixture was kneaded with N-methyl-2-pyrrolidone (NMP) (a separate amount of) to obtain a positive electrode mixture slurry. Consequently, the positive electrode mixture slurry was applied on both surfaces of a positive electrode current collector (aluminum foil: thickness=15 μm) and was dried, this positive electrode current collector was compression-molded using a pressing machine, and then the resultant compression-molded object was punched to obtain a pallet (diameter=15 mm). As the counter electrode 53, a lithium metal plate (diameter=16 mm) was used. In the case of preparing the electrolytic solution, ethylene carbonate (EC) and dimethyl carbonate (DMC) that served as a solvent were mixed, and lithium hexafluorophosphate (LiPF₆) that was an electrolyte salt was dissolved therein. In this case, a composition (mass ratio) of the solvent was set to EC:DMC=50:50, and a content of the electrolyte salt with respect to the solvent was set to 1 mol/dm³ (=1 mol/l).

A charge capacity C1 (vs lithium metal: mAh/cm³) per unit volume during a charge and discharge of a first cycle was obtained by using the secondary battery. In addition, during a charge, a constant current charge was performed until a battery voltage reached a value (a charge voltage of a first cycle) shown in Table 3 with a current corresponding to a current density of 0.2 mA/cm², and then a constant voltage charge was formed until a current value was decreased to 1/10.

Consequently, the secondary battery was discharged, and a discharge capacity D1 (vs lithium metal: mAh/cm³) per unit volume during a charge and discharge of a first cycle, a discharge voltage E, and a charge and discharge efficiency D1/C1 were obtained. In this case, the secondary battery after the charging was discharged, and a discharge capacity D1 (mAh/cm³) per unit volume of a first cycle, and a discharge voltage E(V) were measured. In addition, the charge and discharge efficiency D1/C1(%) of the discharge capacity D1 (mAh/cm³) of the first cycle/the charge capacity C1 (mAh/cm³)×100 was obtained. In addition, during the discharge, the discharge was performed until a battery voltage reached 2.5 V with a current corresponding to a current density of 0.2 mA/cm².

Consequently, a charge capacity C2 (vs lithium metal: mAh/cm³) during a charge and discharge of a second cycle was obtained in the same sequence as the above-described sequence except that the battery voltage was changed to a value (a charge voltage of a second cycle) shown in Table 3.

In addition, a charge capacity ratio C2/C1(%) of (the charge capacity (mAh/cm³) of the second cycle/the charge capacity (mAh/cm³) of the first cycle)×100 was calculated.

In addition, characteristics with respect to the second lithium composite oxide were investigated in the same sequence as that of the first lithium composite oxide.

### Measurement of Discharge Capacity

To obtain a discharge capacity, a laminated film type secondary battery as shown in FIGS. 3 and 4 was manufactured using the above-described positive electrode active material.

First, a positive electrode 33 was manufactured. First, 90 parts by mass of a positive electrode active material (first and second lithium composite oxides), 5 part by mass of a positive electrode conducting agent (ketjen black that is an amorphous carbon powder), and 5 parts by mass of positive electrode binding agent (PVDF) were mixed to obtain a positive electrode mixture. A mixing ratio (weight ratio) of the first and second lithium composite oxides are shown in Table 2. Consequently, the positive electrode mixture was dispersed in an organic solvent (NMP) to obtain a paste-type positive electrode mixture slurry. Consequently, the positive electrode mixture slurry was applied onto both surfaces of a positive electrode current collector 33A (aluminum foil: thickness=12 μm) using a coating device and was dried to form a positive electrode active material layer 33B, and this positive electrode active material layer 33B was compression-molded using a roll pressing machine. In this case, the thickness of the positive electrode active material layer 33B was adjusted such that lithium metal did not precipitate in a negative electrode 34 at a fully charged state. Finally, the positive electrode current collector 33A provided with the positive electrode active material layer 33B was cut into a strip shape (48 mm×300 mm).

Next, a negative electrode 34 was manufactured. First, a negative electrode active material and a negative electrode binding agent (20 wt % NMP solution of polyimide) shown in Table 3 were mixed in a mass ratio of 7:2 to prepare a negative electrode mixture. Consequently, the negative electrode mixture slurry was applied onto both surfaces of a negative electrode current collector 34A (copper foil: thickness=15 μm) by using a bar coater (gap=35 μm) and was dried at 80° C., and thereby a negative electrode active material layer 34B was formed. This negative electrode active material layer 34B was compression-molded by using a roll pressing machine and was heated at a high temperature of 700° C. for three hours, and the negative electrode current collector 34A provided with the negative electrode active material layer 34B was cut into a strip shape (50 mm×310 mm). In addition, with respect to the negative electrode active material, a charge and discharge efficiency was obtained in the same sequence as that in the positive electrode active material, and the results shown in Table 3 were obtained.

Next, LiPF₆ as an electrolyte salt was dissolved in EC and ethylmethyl carbonate (EMC) that served as a solvent and thereby an electrolytic solution was prepared. In this case, a composition (mass ratio) of the solvent was set to EC:EMC=50:50, and a content of the electrolyte salt with respect to the solvent was set to 1 mol/dm³.

Finally, a secondary battery was assembled. First, a positive electrode lead 31 formed of aluminum was welded to one end of the positive electrode current collector 33A, and a negative electrode lead 32 formed of nickel was welded to one end of the negative electrode current collector 34A. Consequently, the positive electrode 33, the separator 35 (minutely porous polyethylene film: thickness=25 μm), the negative electrode 34, and the separator 35 were laminated in this order, and then wound in a longitudinal direction to obtain a wound body that is a precursor of a wound electrode body 30. A winding end portion was fixed using a protective tape 37 (adhesive tape). Consequently, the wound body was interposed between exterior members 40, and the peripheries of the exterior members 40 were bonded to each other through a thermal fusion or the like with one side left to accommodate the wound body in the exterior members 40 having a bag shape. In this case, as the exterior members 40, an aluminum laminated film in which a nylon film (thickness=30 μm), aluminum foil (thickness=40 μm), and a casted polypropylene film (thickness=30 μm) were laminated in this order from an external side was used. Subsequently, the electrolytic solution was injected from an opening portion of the exterior members 40 and was impregnated in the separator 35, and thereby a wound electrode body 30 was obtained. Finally, the opening portion of the exterior members 40 was thermally fused under a vacuum atmosphere and was sealed.

To obtain a discharge capacity, two sets of laminated film type secondary batteries were prepared. A constant current charge was performed using a first set of secondary batteries under an environment (as described below) of 23° C. until a battery voltage reached a value (a charge voltage of a first cycle) shown in Table 3 with a current of 100 mA, and a constant voltage charge was performed until a current reached 1 mA. Then, a constant current discharge was performed until the battery voltage reached 2.5 V with a current of 50 mA. Consequently, the charge and discharge was repeated until the total cycle numbers reached 300 cycles in the same conditions as the above-described conditions except that the content current charge was performed until the battery voltage reached a value (a charge voltage of a second cycle) shown in Table 3, and a discharge capacity (mAh) of a 300^{th} cycle was measured. At this time, by using a second set of secondary batteries, the secondary batteries were disassembled after the charge of the first time, the positive electrode 33 and the negative electrode 34 were taken out, the thickness of the positive electrode active material layer 33B and the negative electrode active material layer 34B were measured using a step difference measuring device, and a total volume of the positive electrode active material layer 33B and the negative electrode active material layer 34B after the charge were calculated. Finally, a discharge capacity (mAh/cm³) per unit volume of a discharge capacity (mAh)/a total volume (cm³) of the positive electrode active material layer 33B and the negative electrode active material layer 34B was calculated.

TABLE 1
Table 1

| | Positive electrode active material (First lithium composite oxide L1) | | | | | |
|---|---|---|---|---|---|---|
| | | | Charge | Charge | Charge and | Discharge |
| | | Charge | capacity | capacity ratio | discharge | efficiency |
| | | capacity of | of second | of first and | efficiency of | of first |
| | | first cycle C1 | cycle C2 | second cycles | first cycle | cycle E |
| | Kind | (mAh/cm³) | (mAh/cm³) | C2/C1 | D1/C1 (%) | (V) |
| Experiment Example 1-1 | LiNi_{0.8}Co_{0.18}Al_{0.02}O₂ | 1099.4 | 912.98 | 0.83 | 89 | 3.80 |
| Experiment Example 1-2 | LiNi_{0.8}Co_{0.18}Al_{0.02}O₂ | 1099.4 | 912.98 | 0.83 | 89 | 3.80 |
| Experiment Example 1-3 | LiNi_{0.8}Co_{0.18}Al_{0.02}O₂ | 1099.4 | 912.98 | 0.83 | 89 | 3.80 |
| Experiment Example 1-4 | LiNi_{0.8}Co_{0.18}Al_{0.02}O₂ | 1099.4 | 912.98 | 0.83 | 89 | 3.80 |
| Experiment Example 1-5 | LiNi_{0.8}Co_{0.18}Al_{0.02}O₂ | 1075.5 | 912.98 | 0.85 | 89 | 3.80 |
| Experiment Example 1-6 | LiNi_{0.8}Co_{0.18}Al_{0.02}O₂ | 1075.5 | 912.98 | 0.85 | 89 | 3.80 |
| Experiment Example 1-7 | LiNi_{0.8}Co_{0.18}Al_{0.02}O₂ | 1099.4 | 912.98 | 0.83 | 89 | 3.80 |
| Experiment Example 1-8 | LiNi_{0.8}Co_{0.18}Al_{0.02}O₂ | 1099.4 | 912.98 | 0.83 | 89 | 3.80 |
| Experiment Example 1-9 | LiNi_{0.8}Co_{0.18}Al_{0.02}O₂ | 1099.4 | 912.98 | 0.83 | 89 | 3.80 |
| Experiment Example 1-10 | LiCoO₂ | 934.8 | 728.16 | 0.78 | 88 | 4.03 |
| Experiment Example 1-11 | LiCoO₂ | 934.8 | 728.16 | 0.78 | 88 | 4.03 |
| Experiment Example 1-12 | LiCoO₂ | 934.8 | 728.16 | 0.78 | 88 | 4.03 |
| Experiment Example 1-13 | LiCoO₂ | 934.8 | 728.16 | 0.78 | 88 | 4.03 |
| Experiment Example 1-14 | LiNi_{0.8}Co_{0.18}Al_{0.02}O₂ | 1099.4 | 912.98 | 0.83 | 89 | 3.80 |
| Experiment Example 1-15 | LiCoO₂ | 934.8 | 728.16 | 0.78 | 88 | 4.03 |
| Experiment Example 1-16 | LiCoO₂ | 934.8 | 728.16 | 0.78 | 88 | 4.03 |

TABLE 2
Table 2

| | Positive electrode active material (Second lithium composite oxide L2) | | | | | |
|---|---|---|---|---|---|---|
| | | | Charge | Charge | Discharge | |
| | | Charge | capacity | capacity ratio | voltage | |
| | | capacity of | of second | of first and | of first | Weight |
| | | first cycle C1 | cycle C2 | second cycles | cycle E | ratio |
| | Kind | (mAh/cm³) | (mAh/cm³) | C2/C1 | (V) | (L1/L2) |
| Experiment Example 1-1 | Li_{1.13}(Mn_{0.6}Co_{0.2}Ni_{0.2})_{0.87}O₂ | 1284.8 | 836 | 0.65 | 3.66 | 1.4 |
| Experiment Example 1-2 | Li_{1.13}(Mn_{0.5}Co_{0.3}Ni_{0.2})_{0.87}O₂ | 1232 | 888.8 | 0.72 | 3.66 | 1.4 |
| Experiment Example 1-3 | Li_{1.13}(Mn_{0.68}Co_{0.2}Ni_{0.12})_{0.87}O₂ | 1368.4 | 748 | 0.55 | 3.66 | 1.4 |
| Experiment Example 1-4 | Li_{1.13}(Mn_{0.6}Co_{0.25}Ni_{0.15})_{0.87}O₂ | 1320 | 792 | 0.60 | 3.67 | 1.4 |
| Experiment Example 1-5 | Li_{1.25}(Mn_{0.6}Co_{0.2}Ni_{0.2})_{0.75}O₂ | 1408 | 748 | 0.53 | 3.65 | 1.4 |
| Experiment Example 1-6 | Li_{1.07}(Mn_{0.6}Co_{0.2}Ni_{0.2})_{0.93}O₂ | 1144 | 924 | 0.81 | 3.66 | 1.4 |
| Experiment Example 1-7 | Li_{1.13}(Mn_{0.6}Co_{0.2}Ni_{0.2})_{0.87}O₂ | 1284.8 | 836 | 0.65 | 3.66 | 3.0 |
| Experiment Example 1-8 | Li_{1.13}(Mn_{0.6}Co_{0.2}Ni_{0.2})_{0.87}O₂ | 1284.8 | 836 | 0.65 | 3.66 | 1.0 |
| Experiment Example 1-9 | Li_{1.13}(Mn_{0.6}Co_{0.2}Ni_{0.2})_{0.87}O₂ | 1284.8 | 836 | 0.65 | 3.66 | 0.3 |
| Experiment Example 1-10 | Li_{1.13}(Mn_{0.6}Co_{0.2}Ni_{0.2})_{0.87}O₂ | 1188 | 836 | 0.70 | 3.66 | 1.6 |
| Experiment Example 1-11 | Li_{1.13}(Mn_{0.5}Co_{0.3}Ni_{0.2})_{0.87}O₂ | 1166 | 849.2 | 0.73 | 3.66 | 1.6 |
| Experiment Example 1-12 | Li_{1.13}(Mn_{0.68}Co_{0.2}Ni_{0.12})_{0.87}O₂ | 1276 | 792 | 0.62 | 3.66 | 1.6 |
| Experiment Example 1-13 | Li_{1.13}(Mn_{0.6}Co_{0.25}Ni_{0.15})_{0.87}O₂ | 1210 | 836 | 0.69 | 3.67 | 1.6 |
| Experiment Example 1-14 | Li_{1.13}(Mn_{0.6}Co_{0.2}Ni_{0.2})_{0.87}O₂ | 1284.8 | 836 | 0.65 | 3.66 | 1.6 |
| Experiment Example 1-15 | Li_{1.13}(Mn_{0.6}Co_{0.2}Ni_{0.2})_{0.87}O₂ | 1188 | 836 | 0.70 | 3.66 | 1.7 |
| Experiment Example 1-16 | Li_{1.13}(Mn_{0.6}Co_{0.2}Ni_{0.2})_{0.87}O₂ | 1188 | 836 | 0.70 | 3.66 | 1.7 |

TABLE 3

| | | | Negative electrode active | | |
|---|---|---|---|---|---|
| | Charge condition | | material | | |
| | Charge | Charge | | Charge and | |
| | voltage of | voltage of | | discharge | Discharge |
| | first cycle | second cycle | | efficiency | capacity |
| Table 3 | (V) | (V) | Kind | (%) | (mAh/cm³) |
| Experiment Example 1-1 | 4.60 | 4.35 | SiO | 70 | 336 |
| Experiment Example 1-2 | 4.60 | 4.35 | SiO | 70 | 331 |
| Experiment Example 1-3 | 4.60 | 4.35 | SiO | 70 | 337 |
| Experiment Example 1-4 | 4.60 | 4.35 | SiO | 70 | 335 |
| Experiment Example 1-5 | 4.55 | 4.35 | SiO | 70 | 335 |
| Experiment Example 1-6 | 4.55 | 4.35 | SiO | 70 | 330 |
| Experiment Example 1-7 | 4.60 | 4.35 | SiO | 70 | 331 |
| Experiment Example 1-8 | 4.60 | 4.35 | SiO | 70 | 331 |
| Experiment Example 1-9 | 4.60 | 4.35 | SiO | 70 | 327 |
| Experiment Example 1-10 | 4.55 | 4.35 | SiO | 70 | 315 |
| Experiment Example 1-11 | 4.55 | 4.35 | SiO | 70 | 312 |
| Experiment Example 1-12 | 4.55 | 4.35 | SiO | 70 | 317 |
| Experiment Example 1-13 | 4.55 | 4.35 | SiO | 70 | 306 |
| Experiment Example 1-14 | 4.60 | 4.35 | Si | 83 | 420 |
| Experiment Example 1-15 | 4.55 | 4.35 | Si | 83 | 400 |
| Experiment Example 1-16 | 4.55 | 4.35 | Sn | 81 | 400 |

### Experiment Examples 2-1 to 2-7

### Synthesis of Positive Electrode Active Material

Characteristics of first and second lithium composite oxides and a lithium ion secondary battery were investigated in the same sequence as that in the experiment examples 1-1 to 1-16 except that the presence or absence of the first and second lithium composite oxides or the like were changed as shown in Tables 4 to 6 for comparison.

TABLE 4
Table 4

| | Positive electrode active material (First lithium composite oxide L1) | | | | | |
|---|---|---|---|---|---|---|
| | | | Charge | Charge | Charge and | Discharge |
| | | Charge | capacity | capacity ratio | discharge | efficiency |
| | | capacity of | of second | of first and | efficiency of | of first |
| | | first cycle C1 | cycle C2 | second cycles | first cycle | cycle E |
| | Kind | (mAh/cm³) | (mAh/cm³) | C2/C1 | D1/C1 (%) | (V) |
| Experiment Example 2-1 | LiNi_{0.8}Co_{0.18}Al_{0.02}O₂ | 1099.4 | 912.98 | 0.83 | 89 | 3.80 |
| Experiment Example 2-2 | LiCoO₂ | 934.8 | 728.16 | 0.78 | 88 | 4.03 |
| Experiment Example 2-3 | LiNi_{0.8}Co_{0.18}Al_{0.02}O₂ | 1003.8 | 908.2 | 0.90 | 90 | 3.77 |
| Experiment Example 2-4 | LiCoO₂ | 836.4 | 777.36 | 0.93 | 93 | 3.97 |
| Experiment Example 2-5 | LiNi_{0.8}Co_{0.18}Al_{0.02}O₂ | 1099.4 | 912.98 | 0.83 | 89 | 3.80 |
| Experiment Example 2-6 | LiCoO₂ | 934.8 | 728.16 | 0.78 | 88 | 4.03 |
| Experiment Example 2-7 | — | — | — | — | — | — |

TABLE 5
Table 5

| | Positive electrode active material (Second lithium composite oxide L2) | | | | | |
|---|---|---|---|---|---|---|
| | | | Charge | Charge | Discharge | |
| | | Charge | capacity | capacity ratio | voltage | |
| | | capacity of | of second | of first and | of first | Weight |
| | | first cycle C1 | cycle C2 | second cycles | cycle E | ratio |
| | Kind | (mAh/cm³) | (mAh/cm³) | C2/C1 | (V) | (L1/L2) |
| Experiment Example 2-1 | — | — | — | — | — | — |
| Experiment Example 2-2 | — | — | — | — | — | — |
| Experiment Example 2-3 | Li_{1.13}(Mn_{0.6}Co_{0.2}Ni_{0.2})_{0.87}O₂ | 536.8 | 497.2 | 0.93 | 3.63 | 1.4 |
| Experiment Example 2-4 | Li_{1.13}(Mn_{0.6}Co_{0.2}Ni_{0.2})_{0.87}O₂ | 536.8 | 497.2 | 0.93 | 3.63 | 1.6 |
| Experiment Example 2-5 | — | — | — | — | — | — |
| Experiment Example 2-6 | — | — | — | — | — | — |
| Experiment Example 2-7 | Li_{1.13}(Mn_{0.6}Co_{0.2}Ni_{0.2})_{0.87}O₂ | 1284.8 | 497.2 | 0.39 | 3.66 | — |

TABLE 6

| | | | Negative electrode active | | |
|---|---|---|---|---|---|
| | Charge condition | | material | | |
| | Charge | Charge | | Charge and | |
| | voltage of | voltage of | | discharge | Discharge |
| | first cycle | second cycle | | efficiency | capacity |
| Table 6 | (V) | (V) | Kind | (%) | (mAh/cm³) |
| Experiment Example 2-1 | 4.60 | 4.35 | SiO | 70 | 322 |
| Experiment Example 2-2 | 4.60 | 4.35 | SiO | 70 | 290 |
| Experiment Example 2-3 | 4.35 | 4.35 | SiO | 70 | 254 |
| Experiment Example 2-4 | 4.35 | 4.35 | SiO | 70 | 242 |
| Experiment Example 2-5 | 4.60 | 4.35 | Si | 83 | 401 |
| Experiment Example 2-6 | 4.55 | 4.35 | Si | 83 | 370 |
| Experiment Example 2-7 | 4.60 | 4.35 | SiO | 70 | 270 |

In a case where the positive electrode active material included the first lithium composite oxide and the second lithium composite oxide in which the charge capacity C1 was larger than that of the first lithium composite oxide and the discharge voltage E was lower than that of the first lithium composite oxide, a higher discharge capacity was obtained compared to a case not satisfying the above-described conditions.

More specifically, in the case of using only the first lithium composite oxide, when a charge and discharge of a first time was performed with a high charge voltage, a charge and discharge efficiency of the negative electrode 34 was low, such that a charge and discharge after the first time was performed with a low charge voltage in a state where a sufficient amount of lithium did not return from the negative electrode 34 to the positive electrode 33. Therefore, during the charge and discharge after the first time, it was difficult to obtain a sufficient battery capacity.

On the other hand, in the case of using only the second lithium composite oxide, when the charge and discharge of the first time was performed with a high charge voltage, a charge capacity ratio C2/C1 of the second lithium composite oxide and a discharge potential were low, such that it was difficult to obtain a sufficient battery capacity.

On the contrary, in the case of using the first and second lithium composite oxides, when the first charge and discharge of the first time was performed with a high charge voltage, the second lithium composite oxide was preferentially consumed to compensate an irreversible capacity, such that the first lithium composite oxide was maintained while being slightly consumed. Furthermore, the lithium ions, which were emitted from the negative electrode 34 during the discharge of the first time, were preferentially occluded in the first lithium composite oxide of a high discharge potential, such that the charge after the first time was performed with a low charge voltage in a state where a sufficient amount of lithium ions returned to the negative electrode 34. Therefore, during the charge and discharge after the first time, the first lithium composite oxide of a high discharge potential was preferentially consumed, such that a high battery capacity was obtained by the first lithium composite oxide.

In addition, when attention was given to a kind of the negative electrode active material, in the case of using oxide (silicon oxide), the discharge capacity tended to decrease more compared to when non-oxide (silicon or tin) was used. This was considered to be because during the charge and discharge of the first time (during when the lithium ions were occluded in the negative electrode 34), a part of lithium ions irreversibly coupled with oxygen in the oxide.

As can be seen from the Tables 1 to 6, when the positive electrode active material included the first lithium composite oxide, and the second lithium composite oxide in which the charge capacity (vs lithium metal) per unit volume during the charge and discharge of the first cycle was larger than that of the first lithium composite oxide, and the discharge voltage (vs lithium metal) was lower than that of the first lithium composite oxide, even when the charge and discharge was repeated, a high battery capacity was obtained.

Hereinbefore, the present disclosure is described with reference to the embodiments and the examples, but the present disclosure is not limited to the embodiments and the examples; various modifications can be made. For example, the positive electrode active material of the embodiments of the present disclosure may be applied to a lithium ion secondary battery in which a capacity of a negative electrode includes a capacity by occlusion and emission of lithium ions and a capacity accompanied with a precipitation and dissolution, and is represented by a sum of the capacities. In this case, a chargeable capacity of a negative electrode is set to be smaller than that of a discharge capacity of a positive electrode.

In addition, in the embodiments and examples, description is given to a case where a structure of the battery is a cylinder type, a laminated film type, or a coin type, or a case where the battery device has a winding structure, but the present disclosure is not limited thereto. The lithium ion secondary battery according to embodiments of the present disclosure may be equally applied to a case where the lithium ion secondary battery has another battery structure such as a square type and a button type, or a case where the battery device has another structure such as a laminated structure.

In addition, in the embodiments and examples, with respect to a composition (a value of a, or the like) of the second lithium composite oxide expressed by equation (1), an appropriate range derived from results of examples is described. However, this description does not absolutely deny a possibility that the composition may depart from the above-described range. That is, the above-described appropriate range is a particularly desirable range to obtain an effect of the present disclosure to the utmost, such that the composition may be deviated from the above-described range as long as the effect of the present disclosure can be obtained. This is true to a composition (a value of d or the like) of the first lithium composite oxide expressed by equations (2) to (4).

In addition, for example, the positive electrode active material or the positive electrode is not limited to an application to the lithium ion secondary battery but may be applied to another device such as a capacitor or the like.

It should be understood that various changes and modifications to the presently preferred embodiments described herein will be apparent to those skilled in the art. Such changes and modifications can be made without departing from the spirit and scope and without diminishing its intended advantages. It is therefore intended that such changes and modifications be covered by the appended claims.

1. A lithium ion secondary battery, comprising:
a positive electrode;
a negative electrode; and
an electrolytic solution,
wherein the positive electrode includes a first lithium composite oxide and a second lithium composite oxide expressed by the following equation (1), as a positive electrode active material, and
a charge capacity (vs lithium metal) per unit volume during a charge and discharge of a first cycle is larger in the second lithium composite oxide compared to the first lithium composite oxide, and a discharge voltage (vs lithium metal) during the charge and discharge of the first cycle is lower in the second lithium composite oxide compared to the first lithium composite oxide,
Li₁₊ₐ(Mn_{b}Co_{c}Ni_{1-b-c})₁₋ₐO₂ (1)
(here, a, b, and c satisfy relationships of 0<a≦0.25, 0.5≦b<0.7, and 0≦c<1−b).

2. The lithium ion secondary battery according to claim 1,
wherein the first lithium composite oxide is at least one kind among compounds expressed by the following equations (2) to (4),
Li_{d}Ni_{1-e-f}MnₑM1_{f}O_{2-g}Xₕ (2)
(here, M1 is at least one kind selected among elements (excluding nickel and manganese) of group 2 to group 15 in an extended periodic table of elements and X is at least one kind among elements of group 16 and group 17 (excluding oxygen (O)). d, e, f, g, and h satisfy relationships of 0≦d≦1.5, 0≦e≦1, 0≦f≦1, −0.1≦g≦0.2, and 0≦h≦0.2),
LiⱼMn₂₋ₖM2ₖOₘFₙ (3)
(here, M2 is at least one kind selected from a group consisting of cobalt, nickel, magnesium (Mg), aluminum (Al), boron, titanium, vanadium (V), chromium (Cr), iron, copper, zinc, molybdenum, tin, calcium (Ca), strontium (Sr), and tungsten (W). j, k, m, and n satisfy relationships of j≧0.9, 0≦k≦0.6, 3.7≦m≦4.1, and 0≦n≦0.1),
LiₚM3_{q}PO₄ (4)
(here, M3 is at least one kind among elements of group 2 to group 15 in an extended periodic table of elements. p and q satisfy relationships of 0≦p≦2 and 0.5≦q≦2).

3. The lithium ion secondary battery according to claim 2,
wherein in equation (2), M1 is at least one kind selected from a group consisting of cobalt, magnesium, aluminum, boron, titanium, vanadium, chromium, iron, copper, zinc, zirconium (Zr), molybdenum, tin, calcium, strontium, and tungsten, and
in equation (4), M3 is at least one kind selected from a group consisting of cobalt, manganese, iron, nickel, magnesium, aluminum, boron, titanium, vanadium, niobium (Nb), copper, zinc, molybdenum, calcium, strontium, tungsten, and zirconium.

4. The lithium ion secondary battery according to claim 1,
wherein a charge capacity ratio (a charge capacity (vs lithium metal) per unit volume during a charge and discharge at a second cycle/a charge capacity (vs lithium metal) per unit volume during the charge and discharge of the first cycle) is larger in the first lithium composite oxide compared to the second lithium composite oxide.

5. The lithium ion secondary battery according to claim 1,
wherein the negative electrode includes a negative electrode active material, and a charge and discharge efficiency (a discharge capacity (vs lithium metal) per unit volume during the charge and discharge of the first cycle/a charge capacity (vs lithium metal) per unit volume during the charge and discharge of the first cycle) is higher in the first lithium composite oxide compared to the negative electrode active material.

6. The lithium ion secondary battery according to claim 1,
wherein the negative electrode contains, as a negative electrode active material, a material including at least one of silicon and tin as a constituent element.

7. The lithium ion secondary battery according to claim 6,
wherein the negative electrode active material is a silicon oxide (SiOₓ: 0.2<x<1.4).

8. A positive electrode active material comprising:
a first lithium composite oxide; and
a second lithium composite oxide expressed by the following equation (1),
wherein a charge capacity (vs lithium metal) per unit volume during a charge and discharge of a first cycle is larger in the second lithium composite oxide compared to the first lithium composite oxide, and a discharge voltage (vs lithium metal) during the charge and discharge of the first cycle is lower in the second lithium composite oxide compared to the first lithium composite oxide.
Li₁₊ₐ(Mn_{b}Co_{c}Ni_{1-b-c})₁₋ₐO₂ (1)
(here, a, b, and c satisfy relationships of 0<a≦0.25, 0.5≦b<0.7, and 0≦c<1−b)

9. A positive electrode comprising, as a positive electrode active material:
a first lithium composite oxide; and
a second lithium composite oxide expressed by the following equation (1),
wherein a charge capacity (vs lithium metal) per unit volume during a charge and discharge of a first cycle is larger in the second lithium composite oxide compared to the first lithium composite oxide, and a discharge voltage (vs lithium metal) during the charge and discharge of the first cycle is lower in the second lithium composite oxide compared to the first lithium composite oxide,
Li₁₊ₐ(Mn_{b}Co_{c}Ni_{1-b-c})₁₋ₐO₂ (1)
(here, a, b, and c satisfy relationships of 0<a≦0.25, 0.5≦b<0.7, and 0≦c<1−b).

10. An electric tool comprising:
a lithium ion secondary battery;
wherein the lithium ion secondary battery including a positive electrode, a negative electrode, and an electrolytic solution is operated as a power source,
the positive electrode includes a first lithium composite oxide and a second lithium composite oxide expressed by the following equation (1), as a positive electrode active material, and
a charge capacity (vs lithium metal) per unit volume during a charge and discharge of a first cycle is larger in the second lithium composite oxide compared to the first lithium composite oxide, and a discharge voltage (vs lithium metal) during the charge and discharge of the first cycle is lower in the second lithium composite oxide compared to the first lithium composite oxide,
Li₁₊ₐ(Mn_{b}Co_{c}Ni_{1-b-c})₁₋ₐO₂ (1)
(here, a, b, and c satisfy relationships of 0<a≦1.25, 0.5≦b<0.7, and 0≦c<1−b).

11. An electric vehicle comprising:
a lithium ion secondary battery;
wherein the lithium ion secondary battery including a positive electrode, a negative electrode, and an electrolytic solution is operated as a power source,
the positive electrode includes a first lithium composite oxide and a second lithium composite oxide expressed by the following equation (1), as a positive electrode active material, and
a charge capacity (vs lithium metal) per unit volume during a charge and discharge of a first cycle is larger in the second lithium composite oxide compared to the first lithium composite oxide, and a discharge voltage (vs lithium metal) during the charge and discharge of the first cycle is lower in the second lithium composite oxide compared to the first lithium composite oxide,
Li₁₊ₐ(Mn_{b}Co_{c}Ni_{1-b-c})₁₋ₐO₂ (1)
(here, a, b, and c satisfy relationships of 0<a≦0.25, 0.5≦b<0.7, and 0≦c<1−b).

12. A power storage system comprising:
a lithium ion secondary battery;
wherein the lithium ion secondary battery including a positive electrode, a negative electrode, and an electrolytic solution is used as a power storage source,
the positive electrode includes a first lithium composite oxide and a second lithium composite oxide expressed by the following equation (1), as a positive electrode active material, and
a charge capacity (vs lithium metal) per unit volume during a charge and discharge of a first cycle is larger in the second lithium composite oxide compared to the first lithium composite oxide, and a discharge voltage (vs lithium metal) during the charge and discharge of the first cycle is lower in the second lithium composite oxide compared to the first lithium composite oxide,
Li₁₊ₐ(Mn_{b}Co_{c}Ni_{1-b-c})₁₋ₐO₂ (1)
(here, a, b, and c satisfy relationships of 0<a≦0.25, 0.5≦b<0.7, and 0≦c<1−b).
